(19) United States
(12) Patent Application Publication
(10) Pub. No.: US 2026/0059224 A1
(43) Pub. Date: Feb. 26, 2026

(54) STORAGE CASE, EARPHONE CASE, AND EARPHONE

(71) Applicant: Nothing Technology Limited, London (GB)

(72) Inventors: Bin Huang, Shenzhen (CN); Wenjiao Dai, Shenzhen (CN); Shuo Liu, Shenzhen (CN); Wen Li, Shenzhen (CN); Hang Du, Shenzhen (CN)

(21) Appl. No.: 19/302,432

(22) Filed: Aug. 18, 2025

(30) Foreign Application Priority Data
Aug. 23, 2024 (CN) 202411172395.3
Aug. 23, 2024 (CN) 202422064226.X

(51) Int. Cl. H04R 1/10

(52) U.S. Cl. CPC H04R 1/1091; H04R 1/1025; H04R 1/105; H04R 2420/07

(57) ABSTRACT

A storage case includes an upper housing and a lower housing. They cooperatively define an accommodating cavity for an object. The lower housing defines a mounting recess. The storage case further includes a first positioning portion and a second positioning portion. The first positioning portion is on an inner surface of the upper housing facing towards the lower housing and protrudes towards the lower housing, and is adjacent to a first part of the mounting recess. The first positioning portion and the first part of the mounting recess constitute a first positioning region. The second positioning portion is on the inner surface of the upper housing facing towards the accommodating cavity. The second positioning portion and a second part of the mounting recess constitute a second positioning region. The first positioning region and the second positioning region cooperatively define a positioning cavity for the object.

### CROSS-REFERENCE TO RELATED APPLICATIONS

This application claims priority under 35 U.S.C. § 119 (a) to Chinese Patent Application No. 2024111723953, filed Aug. 23, 2024, the entire disclosure of which is incorporated herein by reference.

### TECHNICAL FIELD

This disclosure relates to the field of electronic device technology. More specifically, this disclosure relates to a storage case, further relates to an earphone case, and further relates to an earphone.

### BACKGROUND

With the development of society, audio devices are increasing popular among consumers. The audio devices can be used in office, life, or daily travel, so that users can connect the audio devices to electronic devices to realize functions such as telecommuting, watching videos, playing games, listening to music, and voice calls.

### SUMMARY

In order to solve at least one or more of the above-mentioned technical problems, the present disclosure proposes a storage case, an earphone case, and an earphone in various aspects.

In a first aspect, a storage case is provided in the present disclosure. The storage case includes an upper housing and a lower housing. The upper housing and the lower housing cooperatively define an accommodating cavity for an object. The lower housing defines a mounting recess. The storage case further includes a first positioning portion and a second positioning portion. The first positioning portion is disposed on an inner surface of the upper housing facing towards the lower housing. The first positioning portion protrudes towards the lower housing. The first positioning portion is disposed adjacent to a first part of the mounting recess. The first positioning portion and the first part of the mounting recess constitute a first positioning region. The second positioning portion is disposed on an inner surface of the upper housing facing towards the accommodating cavity. The second positioning portion has a flat surface or a curved surface. The second positioning portion faces towards a second part of the mounting recess. The second positioning portion and the second part of the mounting recess constitute a second positioning region. The first positioning region and the second positioning region cooperatively define a positioning cavity for an earphone.

In a second aspect, an earphone case is further provided in the present disclosure. The earphone case includes the storage case. The earphone case is configured to store an earphone.

In some embodiments, an outer surface of a protruding part of the first positioning portion of the earphone case is a curved surface and is symmetrical about a first axis. The mounting recess includes a first mounting recess and a second mounting recess that are symmetrical about the first axis. The first positioning portion and both the first mounting recess and the second mounting recess form multiple first positioning regions.

In some embodiments, the earphone includes a body portion and a battery portion. The first positioning region is configured for positioning the battery portion. The second positioning region is configured for limiting the body portion. The battery portion includes a cylindrical housing. A part of an outer surface of the cylindrical housing is configured to abut against the first part of the mounting recess. A curved surface of the first positioning portion is configured to be tangent to the outer surface of the cylindrical housing, or a shortest distance between the curved surface of the first positioning portion and the outer surface of the cylindrical housing is configured to range from 0.2 mm to 0.5 mm.

In some embodiments, when the upper housing and the lower housing are in a closed state, an inner surface of the first positioning portion and an inner surface of the lower housing that face towards each other abut against each other, or a distance between the inner surface of the first positioning portion and the inner surface of the lower housing that face towards each other ranges from 4 mm to 6 mm.

In some embodiments, a top surface of the body portion of the earphone is a flat surface or a curved surface. The second positioning portion has the flat surface. When the earphone case is in a closed state, the second positioning portion is configured to abut against the top surface of the body portion, or the second positioning portion is configured to be parallel to the top surface of the body portion with a distance ranging from 0.2 mm to 0.5 mm therebetween.

In some embodiments, a top surface of the body portion of the earphone is a flat surface. The second positioning portion has the curved surface. When the earphone case is in a closed state, the curved surface of the second positioning portion is configured to abut against the top surface of the body portion, or a distance between the curved surface of the second positioning portion and the top surface of the body portion is configured to range from 0.2 mm to 0.5 mm.

In some embodiments, the upper housing defines a recess on an outer surface of the upper housing opposite to the first positioning portion. The recess extends towards the accommodating cavity. The first positioning portion has a first curved surface. The recess has a second curved surface. The first curved surface is coaxial with the second curved surface. A curvature of the first curved surface is less than a curvature of the second curved surface, thereby forming a lens.

In some embodiments, a shape of the mounting recess is configured to be adapted to a shape of a part of the earphone extending into the mounting recess. The mounting recess at least includes a body-portion recess, an ear-hook recess, and a battery-portion recess that are sequentially communicated.

In some embodiments, the body-portion recess includes a sound-emitting-portion recess and a connecting-member recess. A depth of the sound-emitting-portion recess is larger than a depth of the connecting-member recess. The depth of the sound-emitting-portion recess is larger than a depth of the battery-portion recess. A depth of the ear-hook recess at a middle region of the ear-hook recess is larger than the depth of the sound-emitting-portion recess. A depth of the ear-hook recess at a region of the ear-hook recess close to the connecting-member recess is larger than the depth of the connecting-member recess. A depth of the ear-hook recess at a region of the ear-hook recess close to the battery-portion recess is smaller than the depth of the battery-portion recess.

In some embodiments, a flexible pad is provided at a bottom of each of the body-portion recess and the battery-portion recess.

In some embodiments, a first magnetic member is provided in the sound-emitting-portion recess and/or the connecting-member recess. The first magnetic member is configured to magnetically attract a body portion of the earphone.

In some embodiments, the lower housing is provided with a stopper. The stopper is disposed at a sidewall of the battery-portion recess away from the first positioning portion. The stopper, the battery-portion recess, and the first positioning portion cooperatively constitute a third positioning region for positioning a cylindrical surface of a battery portion of the earphone.

In some embodiments, the stopper is provided with a functional member. The functional member includes a sensor or a charging contact.

In some embodiments, a second magnetic member is provided at an inner side of the stopper and/or in the battery-portion recess. The second magnetic member is configured to magnetically attract the battery portion of the earphone.

In some embodiments, the upper housing is provided with multiple first positioning portions on the inner surface of the upper housing. The multiple first positioning portions form a multiple positioning points or positioning lines. The multiple first positioning portions are configured to limit the earphone by means of point or line contracts between the multiple positioning points or positioning lines and an opposite region of an earphone housing.

In some embodiments, the earphone case defines two independent cavities symmetrical about a first axis of symmetry. The battery-portion recess in each of the two cavities is defined close to a first axis. The body-portion recess in each of the two cavities is defined away from the first axis relative to the battery-portion recess.

In a third aspect, an earphone is provided in the present disclosure. The earphone is placed in the earphone case.

In some embodiments, the earphone includes a body portion and a battery portion. A top surface of the body portion is a flat surface or a curved surface. When the earphone is placed in the mounting recess of the earphone case and the upper housing and the lower housing of the earphone case are in a closed state, the top surface of the body portion is configured to abut against or to be spaced apart from the inner surface of the upper housing within a certain range, an outer surface of the battery portion is configured to be tangent to an outer surface of the first positioning portion on the upper housing, or a shortest distance between the outer surface of the first positioning portion and the outer surface of the battery portion is configured to range from 0.2 mm to 0.5 mm.

In some embodiments, the earphone includes a stepped portion between a sound-emitting portion of the body portion and a connecting portion of the body portion.

According to the storage case provided in the embodiments of the present disclosure, the first positioning portion protrudes from the inner surface of the upper housing, and the first positioning portion and the first part of the corresponding mounting recess constitute the first positioning region. The inner surface of the upper housing is further provided with the second positioning portion, and the second positioning portion and the second part of the corresponding mounting recess constitute the second positioning region. The first positioning region and the second positioning region cooperatively define a positioning cavity for the earphone. The positioning cavity can better limit the object and prevent the object from shaking and shifting in the accommodating case.

### BRIEF DESCRIPTION OF THE DRAWINGS

The above-mentioned and other objectives, features, and advantages of exemplary implementations of the present disclosure will become readily apparent from the following detailed description, which proceeds with reference to the accompanying drawings. In the accompanying drawings, several implementations of the present disclosure are illustrated exemplarily rather than restrictively, and identical or corresponding reference numerals refer to identical or corresponding parts, in which:

FIG. 1 is a schematic structural view of an earphone case according to an embodiment of the present disclosure.

FIG. 2 is a top view of an earphone case according to an embodiment of the present disclosure.

FIG. 3 is schematic structural view of an inner surface of an upper housing of an earphone case according to an embodiment of the present disclosure.

FIG. 4 is a schematic view of an inner surface of a lower housing according to an embodiment of the present disclosure.

FIG. 5 is a cross-sectional view of an earphone case according to an embodiment of the present disclosure.

FIG. 6 is a left view of an earphone case according to an embodiment of the present disclosure.

FIG. 7 is a right view of an earphone case according to an embodiment of the present disclosure.

FIG. 8 is a schematic view of an embodiment of the present disclosure when an inner sidewall of a first housing is a smooth inclined surface.

FIG. 9 is schematic structural view of a human ear.

FIG. 10 is a front view of an earphone of the present disclosure worn on a human ear.

FIG. 11 is a side view of an earphone of the present disclosure worn on a human ear.

FIG. 12 is a bottom view of an earphone according to an embodiment of the present disclosure.

FIG. 13 is a front view of an earphone according to an embodiment of the present disclosure.

FIG. 14 is a rear view of an earphone according to an embodiment of the present disclosure.

FIG. 15 is a top view of an earphone according to an embodiment of the present disclosure.

FIG. 16 is a perspective view of an earphone according to an embodiment of the present disclosure.

### DETAILED DESCRIPTION

Technical solutions in embodiments of the present disclosure will be described clearly and completely hereinafter with reference to the drawings in the embodiments of the present disclosure. Obviously, the embodiments to be described are merely some rather than all embodiments of the present disclosure. All other embodiments obtained by those skilled in the art based on the embodiments of the present disclosure without creative efforts shall fall within the protection scope of the present disclosure.

It should be understood that terms “including” and “comprising” used in the specification and the claims indicate the presence of a feature, an entity, a step, an operation, an element, and/or a component, but do not exclude the existence or addition of one or more other features, entities, steps, operations, elements, components, and/or collections thereof.

It should also be understood that the terms used in the specification of the present disclosure are merely intended to describe specific embodiments rather than to limit the present disclosure. As being used in the specification and the claims of the present disclosure, unless the context clearly indicates otherwise, singular forms “a”, “an”, and “the” are intended to include plural forms. It should also be understood that a term “and/or” used in the specification and the claims of the present disclosure refers to any and all possible combinations of one or more of relevant listed items and includes these combinations.

As being used in this specification and the claims, a term “if” may be interpreted as “when”, or “once” or “in response to a determination” or “in response to a case where something is detected” depending on the context. Similarly, depending on the context, a clause “if it is determined that” or “if [a described condition or event] is detected” may be interpreted as “once it is determined that”, or “in response to a determination”, or “once [a described condition or event] is detected”, or “in response to a case where [a described condition or event] is detected”.

Specific implementations of the present disclosure are described in detail below with reference to the accompanying drawings.

In public places or office places, in order to avoid noise caused by the audio device disturbing others, the user usually uses earphones in conjunction with the audio device. With the progress of science and technology, Bluetooth earphones are deeply loved by people because of advantages such as no wires. The Bluetooth earphones are usually used in conjunction with an earphone case. When not in use, the Bluetooth earphones are placed in the earphone case; and when in use, the Bluetooth earphones are taken out of the earphone case and worn. In addition, the earphone case also serves as a portable mobile power source. When charging, it is only necessary to place the Bluetooth earphones into the corresponding earphone recesses.

However, when carrying the earphone case outdoors, the Bluetooth earphones placed in the earphone case are prone to shifting under frequent vibrations, and may collide with the earphone case to generate abnormal sound. As a result, incomplete or poor contact between charging contacts and the Bluetooth earphones may even occur, thereby affecting charging and impairing the user experience.

In view of this, there is an urgent need to provide an earphone case and an earphone. The earphone case can better limit the earphone placed in the earphone case, and prevent the earphone from being shifted in the earphone case and affecting charging.

A storage case is provided in the present disclosure. The storage case includes an upper housing and a lower housing. The upper housing and the lower housing cooperatively define an accommodating cavity for an object. The lower housing defines a mounting recess. The storage case further includes a first positioning portion and a second positioning portion. The first positioning portion is disposed on an inner surface of the upper housing facing towards the lower housing, and the first positioning portion protrudes towards the lower housing. The first positioning portion is disposed adjacent to a first part of the mounting recess. The first positioning portion and the first part of the mounting recess constitute a first positioning region. The second positioning portion is disposed on the inner surface of the upper housing facing towards the accommodating cavity. The second positioning portion has a flat surface a curved surface. The second positioning portion faces towards a second part of the mounting recess. The second positioning portion and the second part of the mounting recess constitute a second positioning region. The first positioning region and the second positioning region cooperatively define a positioning cavity for the object.

The storage case in the present disclosure defines the positioning cavity for an earphone, where the positioning cavity is cooperatively defined by the first positioning region and the second positioning region. The positioning cavity can better limit the object inside the storage case and prevent the object from shaking and bumping in the storage case.

In some embodiments, an earphone case is provided in the present disclosure. The earphone case includes the storage case described above for storing an earphone.

The following will take the earphone case as an example to provide a detailed description of the positioning cavity inside the storage case.

An earphone case 100 in the present disclosure includes an upper housing 101 and a lower housing 102. The lower housing 102 defines a mounting recess adapted to the shape of an earphone. The upper housing 101 is provided with a positioning portion for positioning the earphone. When the earphone is placed in the mounting recess, the upper housing 101 and the lower housing 102 are closed together, and the positioning portion on the upper housing 101 and the mounting recess on the lower housing 102 jointly limit the earphone. Therefore, the earphone is secured in an accommodating cavity, and the earphone is prevented from shifting and shaking in the earphone case 100.

As illustrated in a schematic view of an earphone case in FIG. 1, the upper housing 101 and the lower housing 102 of the earphone case 100 provided in the present disclosure both have open structures, and the upper housing 101 and the lower housing 102 cooperatively define the accommodating cavity for accommodating the earphone. Specifically, the earphone case 100 in the present disclosure has a certain extension length, the upper housing 101 and the lower housing 102 are rotatably connected by a rotating shaft disposed along a first side-edge in a direction of extension length, and a second side-edge opposite to the first side-edge serves as an opening and closing region. During use, the upper housing 101 in the opening and closing region rotates around the rotating shaft to open or close the earphone case 100.

In embodiments of the present disclosure, a side surface where the opening and closing region is located is a front viewing region, a side surface where the rotating shaft is located is a rear viewing region, and left and right end portions of the earphone case are respectively a left viewing region and a right viewing region.

In order to facilitate the understanding of the embodiment of the present disclosure, the mounting recess in the embodiments will be described below.

As illustrated in a schematic view of a lower housing of an earphone case in FIG. 4, the mounting recess includes a body-portion recess, an ear-hook recess 1023, and a battery-portion recess 1024 that are sequentially communicated. The body-portion recess is for accommodating an earphone body. The ear-hook recess 1023 is for accommodating an ear hook. The battery-portion recess 1024 is for accommodating a battery portion. The body-portion recess includes a sound-emitting-portion recess 1021 and a connecting-member recess 1022 that are sequentially communicated. The connecting-member recess 1022 is in communication with one end of the ear-hook recess.

The mounting recess in the present disclosure includes a first mounting recess and a second mounting recess symmetrical about a first axis, where the first axis is a midperpendicular line of both ends of the earphone case 100 in the length direction of the earphone case 100. The following description will take the first mounting recess on the left side as an example. The body-portion recess is defined in the middle region and extends obliquely towards a position of the second side-edge close to the left end region, and an extending tail end of the body-portion recess is in communication with the ear-hook recess 1023. The ear-hook recess 1023 first extends from the second side-edge towards the first side-edge, and then obliquely extends towards the first axis close to the first side-edge. An extending tail end of the ear-hook recess 1023 is in communication with the battery-portion recess 1024. The battery-portion recess 1024 further extends towards the first axis close to the Second side-edge. Similarly, the second mounting recess and the first mounting recess are symmetrical about the first axis. The second mounting recess is different from the first mounting recess in that the body-portion recess of the second mounting recess extends towards the right side, while the remaining extension directions are the same as those of the first mounting recess. It is worth noting that extension tracks of the body-portion recess and the battery-portion recess 1024 are linear, and an extension track of the ear-hook recess 1023 is curved.

In the embodiment of the present disclosure, the earphone case has two independent cavities symmetrical about the first symmetry axis, and the first mounting recess and the second mounting recess are respectively located in the two independent cavities. Furthermore, based on the arrangement form of the mounting recess in this embodiment, when the user uses the earphone case, an opening and closing portion of the earphone case faces towards a human body, and the rotating shaft is on the side of the earphone case facing away from the human body. At this time, the first mounting recess on the left side of the earphone case corresponds to the left-hand side of the user, and the second mounting recess on the right side of the earphone case corresponds to the right-hand side of the user; and a left earphone is placed in the first mounting recess, and a right earphone is placed in the second mounting recess.

When the user wears the earphone with any one hand, the user pinches the body portion and takes the earphone out of the earphone case, then moves the sound-emitting portion towards the human ear. When the earphone is moved to the position of the human ear, and the ear hook is suspended above the human ear, the sound-emitting portion of the earphone is secured in a cavity of auricular concha. After that, by moving the wrist downward or lifting an elbow upward, the connecting member of the earphone can inclinedly pass through a region between a crus of helix and a tragus of the human ear. Therefore, in this embodiment of the present disclosure, on the basis that the battery-portion recess is defined close to the first axis, the body-portion recess is defined away from the first axis relative to the battery-portion recess, the ear hook is disposed close to the rotating shaft, and the body portion is disposed close to the opening and closing portion. Therefore, during the wearing of the earphone, it is unnecessary to switch hands or to take out the earphone with the other hand to assist in adjusting the direction before wearing. In this embodiment, the earphones can be worn with one hand only. In addition, in this embodiment, the direction in which the sound-emitting portion of the earphone faces is the same as the direction in which the palm faces, and the left side corresponds to the left ear and the right side corresponds to the right ear, so that it is convenient to take and place the earphones, and it is convenient for the user to wear the earphones with one hand.

In addition, the earphone in the present disclosure does not have a flat surface structure in the thickness direction of the earphone. In order to better limit the earphone, the depths of the mounting recess at respective parts of the mounting recess are different. Specifically, the depth of the ear-hook recess at the middle region of the ear-hook recess is larger than the depth of the sound-emitting-portion recess 1021. The depth of the sound-emitting-portion recess 1021 is larger than the depth of the connecting-member recess 1022. The depth of the ear-hook recess at the region of the ear-hook recess close to the connecting-member recess 1022 is larger than the depth of the connecting-member recess 1022. The depth of the ear-hook recess at the region of the ear-hook recess close to the battery-portion recess is smaller than the depth of the battery-portion recess. In this embodiment, the thickness direction of the earphone body refers to a direction in which the earphone is close to or away from the human ear when the earphone is worn.

In order to facilitate the understanding of the present disclosure, the reason for different depths of the mounting recess is described in detail below. The earphones in the present disclosure are open-type earphones. When in use, the user secures the earphone 200 on the human ear through the ear hook. The human ear usually extends outwards obliquely relative to the side surface of the head, defining an angle between the human ear and the head. In order to better adapt to the human ear, the ear hook of the earphone in this embodiment is inclined relative to the earphone body. That is, the ear hook has an inclination with respect to the thickness direction of the earphone body, and an inclination angle tends to be the same as the angle defined between the human ear and the head. In order to better place the ear hook in the ear-hook recess, the depth of the ear-hook recess at the middle region of the ear-hook recess is thus designed as the deepest.

Since the body portion of the earphone includes the sound-emitting portion and the connecting member, and a lower surface of the sound-emitting portion close to an ear canal exceeds a lower surface of the connecting member close to the ear canal, the depth of the sound-emitting-portion recess 1021 that accommodates the sound-emitting portion is larger than the depth of the connecting-member recess 1022 that accommodates the connecting member.

Moreover, one end of the ear hook is connected to the connecting member, and the other end of the ear hook is connected to the battery portion. When the earphone is in a wearing state, the end of the ear hook connected to the connecting member is located at a region of the human ear close to the human face. Therefore, the ear hook at the region of the human ear close to the human face extends obliquely towards the lower surface of the earphone body, and the ear hook at the middle region of the ear hook extends obliquely towards the upper surface of the earphone body. An extending tail end of the ear hook is connected to the battery portion, and the upper end of the battery portion away from the ear canal is slightly lower than the upper end of the connecting member or almost flush with the upper end of the connecting member. Therefore, the depth of the battery-portion recess is slightly lower than the depth of the sound-emitting-portion recess 1021 or equal to the depth of the sound-emitting-portion recess 1021, the depth of ear-hook recess at the region of the ear-hook recess close to the connecting-member recess 1022 is larger than the depth of the connecting-member recess 1022, and the depth of the ear-hook recess at the region of the ear-hook recess close to the battery recess is smaller than the depth of the battery-portion recess.

In the embodiment of the present disclosure, the earphone case is provided with a battery therein. The battery is specifically disposed in the middle region inside the lower housing of the earphone case. Specifically, as illustrated in the schematic view of the lower housing of the earphone case in FIG. 4, in this embodiment, the depth of the ear-hook recess 1023 at the middle region of the ear-hook recess 1023 is the largest, and the middle region of the ear-hook recess 1023 is located at each of both ends of the earphone case. With this depth design, the depth of the mounting recess at the middle region of the earphone case is relatively shallow, so that a sufficiently large space is provided below this region to accommodate the battery. Therefore, the battery inside the lower housing of the earphone case can be made thicker as a single component, and it is no longer necessary to divide the battery into two parts for separate mounting below the first mounting recess and the second mounting recess. Instead, it can be formed as a single integrated piece mounted between the two ear-hook recesses. With this design, it is possible to increase the battery capacity and simplify the stacking design when manufacturing the earphone case.

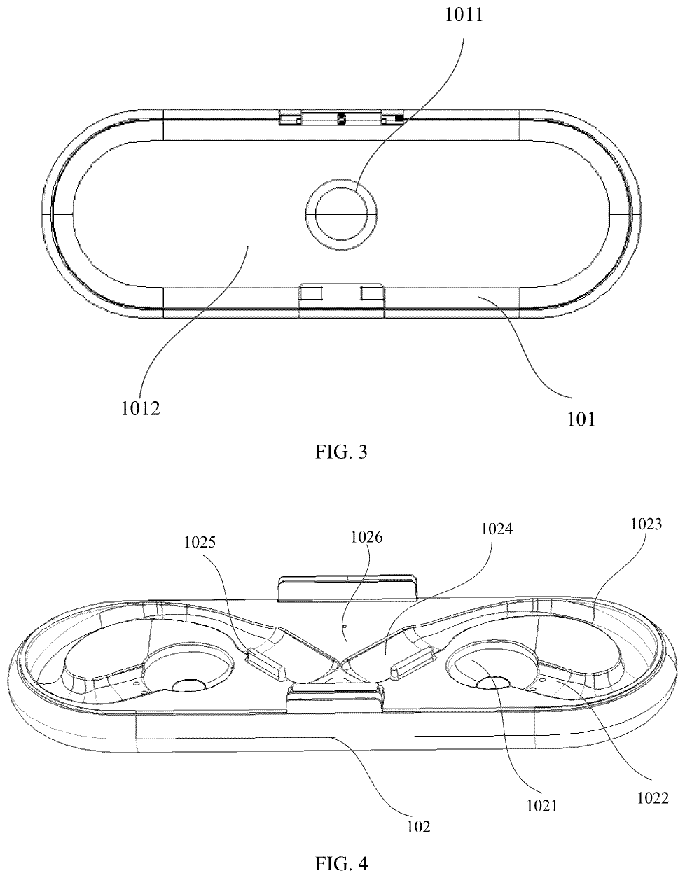

As illustrated in the schematic view of the inner surface of the earphone case in FIG. 3, in an implementation, the positioning portion on the upper housing 101 for positioning the earphone includes a first positioning portion 1011 and a second positioning portion 1012. The first positioning portion 1011 protrudes from the inner surface of the upper housing 101 and extend towards the lower housing 102. That is, the first positioning portion 1011 is a protruding structure disposed on the inner surface of the upper housing 101. The protruding structure is disposed on the first axis and symmetrical about the first axis. In the present disclosure, since the battery-portion recess 1024 of the first mounting recess and the battery-portion recess 1024 of the second mounting recess are disposed opposite and obliquely, the two battery-portion recesses 1024 forms a V-shaped region 1026 with an opening facing the first side-edge. When the upper housing 101 and the lower housing 102 are in a closed state, a part of a projection of the first positioning portion 1011 on the lower housing 102 falls into the V-shaped region 1026, and another part of the projection of the first positioning portion 1011 on the lower housing 102 falls into the battery-portion recesses 1024. Said another part of the projection of the first positioning portion 1011 falls into the battery-portion recess 1024 is defined as the first part. The first part and the first positioning portion 1011 disposed above the first part together constitute a first positioning region. Moreover, since the projection of the first positioning portion 1011 falls into both the battery-portion recess 1024 of the first mounting recess and the battery-portion recess 1024 of the second mounting recess, the first positioning portion 1011 and the first parts of the two battery-portion recesses 1024 together constitute two first positioning regions.

In the above-mentioned embodiment, the second positioning portion 1012 is also provided on the inner surface of the upper housing 101 facing towards the accommodating cavity. The second positioning portion has a flat surface or a curved surface. The second positioning portion 1012 is disposed opposite to the second part of the mounting recess, and the second positioning portion 1012 and the second part constitute the second positioning region. In one implementation of this embodiment, the second part of the mounting recess refers to the body-portion recess which has an orthographic projection on the inner surface of the upper housing. The body-portion recess and the second positioning portion 1012 constitute the second positioning region. When the earphone is mounted in the mounting recess and the upper housing and the lower housing are in a closed state, the top surface of the body portion of the earphone abuts against the second positioning portion 1012 on the inner surface of the upper housing, so that the second positioning portion and the body-portion recess jointly limit the earphone.

In another implementation of this embodiment, when the earphone is mounted in the mounting recess, a plane on which the top surface of the earphone body is located and a plane on which the uppermost end of the battery portion is located are set to be coplanar. In this implementation, the second part of the mounting recess refers to the body-portion recess and the battery-portion recess which have respective orthographic projections on the inner surface of the upper housing. The body-portion recess and the second positioning portion corresponding to the projection of the body-portion recess, and the battery-portion recess and the second positioning portion corresponding to the projection of the battery-portion recess together define the second positioning region. When the upper housing and the lower housing are in a closed state, the top surface of the body portion of the earphone abuts against the inner surface of the upper housing, and the uppermost end of the battery portion abuts against the inner surface of the upper housing. That is, the second positioning region respectively limits both ends of the earphone, i.e., the body portion and the battery portion. In this embodiment, since the part of the ear hook at the middle region of the ear hook is completely located in the ear-hook recess, it is sufficient to limit only the two ends of the earphone to achieve overall positional limitation of the earphone.

In another implementation, the position of the first positioning portion 1011 is different from that in the above-mentioned embodiments. In this embodiment, the projection of the first positioning portion 1011 on the lower housing 102 only falls into the V-shaped region 1026, and the outermost edge of the projection is located at the sidewall of the battery-portion recess 1024. In this embodiment, the lower end of the first positioning portion 1011 on the upper housing 101 abuts against the surface of the V-shaped region 1026, or there is a certain distance between the lower end of the first positioning portion 1011 and the surface of the V-shaped region 1026, to limit the earphone.

In the above-mentioned embodiment, when the earphone is mounted in the battery-portion recess, the part of the earphone located outside the battery-portion recess accounts for at least fifty percent of the total volume of the earphone. Therefore, when the first positioning portion 1011 abuts against the outer surface of the battery portion at a central axis in the horizontal direction, the first positioning portion 1011 can limit the battery portion in the horizontal direction. When the first positioning portion 1011 abuts against the outer surface of the battery portion above the central axis in the horizontal direction, the first positioning portion 1011 can limit the battery portion in a downward-sloping manner.

The second positioning region in the present disclosure can limit the earphone in both the vertical direction and the horizontal direction. On this basis, the first positioning region is defined, and the first positioning region cannot only limit the earphone in the horizontal direction but also in other directions. Therefore, the earphone in the embodiment can be more securely limited in the positioning cavity, thereby preventing the shifting of the earphone in the earphone case 100, and avoiding adverse effects on changing.

In the embodiment of the present disclosure, in order to provide the user with a better visual effect, the upper housing 101 of the earphone case 100 is a transparent housing or a translucent housing, so that the user can observe the earphone through the upper housing 101 without needing to open the earphone case 100.

Of course, in other embodiments, a part of the lower housing of the earphone case may also be designed as a transparent or translucent housing. For example, both ends of the earphone case in the length direction of the earphone case may be a transparent housing, so that the user can further see more parts of the earphone through the housing.

In the embodiment of the present disclosure, the earphone includes the body portion and the battery portion. The battery portion is limited in the first positioning region. The body portion is limited in the second positioning region. The battery portion includes a cylindrical housing. A part of an outer surface of the cylindrical housing abuts against the first part of the mounting recess. The outer surface of the housing is tangent to a curved surface of the first positioning portion, or a shortest distance between the outer surface of the cylindrical housing and the curved surface of the first positioning portion ranges from 0.2 mm to 0.5 mm.

In the above-mentioned embodiment, since the outer surface of the first positioning portion maintains a certain distance from the housing of the battery portion, the tolerance can be accommodated, the contract can be reduced, and the earphone can be avoided from being scratched.

In one implementation, the earphone matched with the earphone case 100 in this embodiment is an open-type earphone. The open-type earphone includes an earphone body, an ear hook, and a battery portion connected in sequence. The battery portion at least includes a battery and a cylindrical housing disposed on the outer periphery of the battery. The first positioning portion 1011 on the upper housing 101 has a protruding structure with a curved outer surface. When the earphone is placed in the mounting recess and the upper housing 101 and the lower housing 102 are in a closed state, the outer surface of the housing of the battery portion is tangent to the curved surface of the first positioning portion 1011, that is, the first positioning portion 1011 abuts against the battery portion to limit the battery portion, thereby preventing shifting of the battery portion and ensuring proper charging.

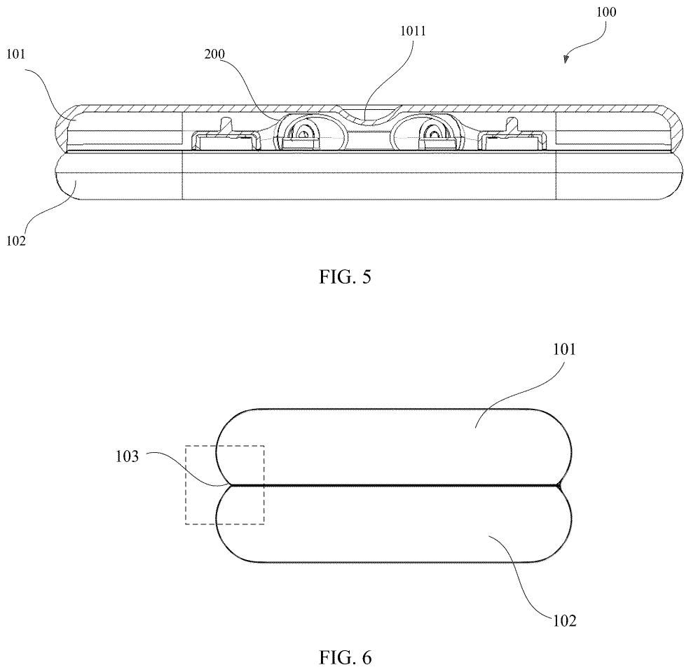

As illustrated in a cross-sectional view of the earphone case in a vertical direction from the upper housing to the lower housing in FIG. 5, in another implementation, a circumferential surface of the battery portion does not abut against the curved surface of the first positioning portion 1011, but instead there is a gap between the circumferential surface of the battery portion and the first positioning portion 1011. Specifically, the shortest distance between the circumferential surface of the battery portion and the curved surface of the first positioning portion 1011 ranges from 0.2 mm to 0.5 mm. Since there is a tolerance space between the charging place and the earphone, shifting of the earphone in the tolerance space does not affect charging. Therefore, the distance between the battery portion and the first positioning portion 1011 is set to range from 0.2 mm to 0.5 mm, so that the first positioning portion 1011 can limit the shifting of the battery portion within a certain range without affecting charging.

In a specific implementation, the distance between the circumferential surface of the battery portion and the curved surface of the first positioning portion is 0.3 mm. Of course, in other specific implementations, the distance between the circumferential surface of the battery portion and the curved surface of the first positioning portion may also be other values between 0.2 mm and 0.5 mm.

In the embodiment of the present disclosure, the first positioning portion is made of a transparent material, and the surface of the first positioning portion does not abut against the battery portion. This arrangement can effectively reduce a contact region between the earphone and the first positioning portion, reduce the scratch on the inner side of the first positioning portion, and improve the durability of the first positioning portion. Moreover, since the upper housing of the earphone case in this embodiment is the transparent housing, the earphone details can be clearly displayed in terms of appearance.

When the earphone is placed in the earphone case, the battery portion will come into contact with the first positioning portion as the earphone shakes along with the earphone case. Since the conduction of force does not require the entire surface to carry the load, the outer surface of the first positioning portion in this embodiment is designed to have a curved surface, so that the earphone can be limited by point or line contact between the earphone and the first positioning portion. In this embodiment, the first positioning portion is configured as a raised curved surface, so that the volume of the first positioning portion can be reduced compared with the first positioning portion being configured as a cylinder, thereby saving materials.

In the embodiment of the present disclosure, when the upper housing 101 and the lower housing 102 are in a closed state, the first positioning portion 1011 abuts against an inner surface of the lower housing 102 that faces towards the first positioning portion 1011; or a distance between the first positioning portion 1011 and the inner surface of the lower housing 102 that faces towards the first positioning portion 1011 ranges from 4 mm to 6 mm.

In this embodiment, when the projection of the first positioning portion 1011 on the lower housing 102 falls only into the V-shaped region 1026, the first positioning portion 1011 may or may not abut against a surface of the lower housing 102 in the V-shaped region 1026. Specifically, in one implementation, an extension length of the first positioning portion 1011 is relatively long, and when the upper housing 101 and the lower housing 102 are in a closed state, a lower end of the first positioning portion 1011 abuts against the inner surface of the lower housing 102, and the first positioning portion can support the upper housing so that the upper housing is not easily collapsed when the upper housing is pressed. In another implementation, in order to save materials, the extension length of the first positioning portion 1011 does not need to be designed very long, that is, when the upper housing 101 and the lower housing 102 are in a closed state, the lower end of the first positioning portion 1011 does not need to abut against the inner surface of the lower housing 102, instead, there is a certain distance between the lower end of the first positioning portion 1011 and the inner surface of the lower housing 102, and the distance may range from 4 mm to 6 mm.

In a specific embodiment, the distance between the first positioning portion and the inner surface of the lower housing is 5 mm. Of course, in other specific embodiments, the distance may also be other values between 4 mm and 6 mm.

In this embodiment, since there is a distance between the first positioning portion and the lower housing, that is, the first positioning portion does not excessively protrude, the risk of stress occurring in the first positioning portion during irregular-shaped injection molding in the production process can be reduced, and the risk of stress in the first positioning portion after the production can also be lowered.

In this embodiment, since the battery portion exceeds the battery-portion recess 1024, the extension length of the first positioning portion 1011 only needs to be sufficient to abut against the battery portion, and the first positioning portion 1011 can limit the battery portion without extending to the inner surface of the lower housing 102.

In the embodiment of the present disclosure, in the process of placing the earphone into the earphone case by the user, in order to reduce bumping or abnormal noise caused by contact when the earphone comes into contact with the mounting recess, a flexible pad is provided at the bottom of each of the body-portion recess and the battery-portion recess. In addition, the flexible pad can also accommodate machining tolerances of the body-portion recess and the battery-portion recess.

In the embodiment of the present disclosure, the top surface of the body portion of the earphone is a flat surface, and the second positioning portion 1012 has a flat surface. When the earphone case is in a closed state, the second positioning portion 1012 abuts against the top surface of the body portion, or the second positioning portion 1012 is parallel to the top surface of the body portion with a distance ranging from 0.2 mm to 0.5 mm therebetween.

In a specific implementation, the top surface of the body portion of the earphone is the flat surface. The top surface of the body portion refers to the upper surface of the body portion, and a surface of the body portion that is opposite to the upper surface of the body portion is a lower surface. When the earphone is mounted in the earphone case, the lower surface of the body portion abuts against the body-portion recess, and the upper surface of the body portion abuts against the second positioning portion to be limited. When the upper surface of the body portion does not abut against the second positioning portion, the distance between the upper surface of the body portion and the second positioning portion ranges from 0.2 mm to 0.5 mm.

In the embodiment of the present disclosure, the top surface of the body portion of the earphone is a flat surface. The second positioning portion has the curved surface. When the earphone case is in a closed state, the curved surface of the second positioning portion abuts against the top surface of the body portion, or a distance between the curved surface of the second positioning portion and the top surface of the body portion ranges from 0.2 mm to 0.5 mm.

In a specific implementation, the second positioning portion may not have the flat surface, but the curved surface, and the curved surface of the second positioning portion is raised towards the lower housing. When the earphone is mounted in the earphone case, the curved surface of the second positioning portion abuts against the upper surface of the body portion, and the curved surface of the second positioning portion and the upper surface of the body portion limit the body portion by means of point contact or line contact. Alternatively, when the earphone is mounted in the earphone case, the curved surface of the second positioning portion does not abut against the upper surface of the body portion, and the distance between the curved surface of the second positioning portion and the upper surface of the body portion is any value from 0.2 mm to 0.5 mm.

In the above-mentioned embodiment, since there is a certain distance between the curved upper surface or the flat upper surface of the body portion and the second positioning portion, the tolerance can be accommodated, and the bumping of the earphone and the abnormal noise caused by bumping can also be effectively reduced.

In the embodiment of the present disclosure, the upper housing defines a recess on an outer surface of the upper housing opposite to the first positioning portion. The recess extends towards the accommodating cavity. The first positioning portion has a first curved surface. The recess has a second curved surface. The first curved surface is coaxial with the second curved surface. A curvature of the first curved surface is less than a curvature of the second curved surface, thereby forming a lens.

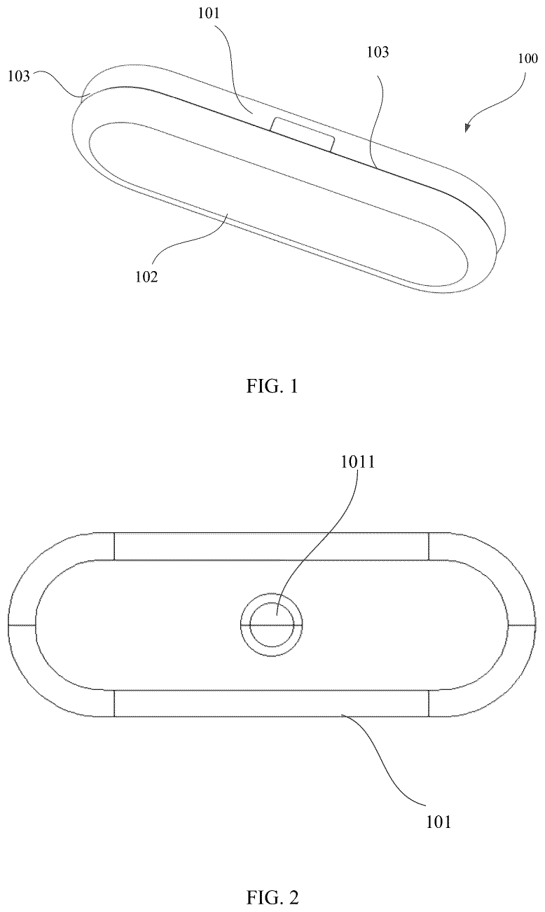

As illustrated in a top view of the earphone case in FIG. 2, in the above-mentioned embodiment, the first positioning portion is recessed and extends in a direction from the outer surface of the upper housing to the inner surface of the upper housing, and protrudes from the inner surface of the upper housing. That is, the outer surface of the first positioning portion is not a flat surface; instead, there is a recessed region in the central region of the outer surface of the first positioning portion, and the recessed region is defined correspondingly to the first positioning portion. In the embodiment of the present disclosure, since there is the recess defined on the upper surface of the upper housing, the user can distinguish the upper housing from the lower housing by tactile feeling.

Specifically, the first positioning portion has the first curved surface. The recess has the second curved surface. The first curved surface is coaxial with the second curved surface. In a specific embodiment, the curvature of the first curved surface is less than the curvature of the second curved surface. In other words, the protrusion height of the first curved surface is larger than the protrusion height of the second curved surface, that is, the upper housing is thinest at the center of the upper housing, and the recess and the first positioning portion form a lens. Furthermore, since the upper housing is made of a transparent material, a unique visual effect is created at the recess.

It can be understood by those skilled in the art that, depending on different design requirements, the curvature of the first curved surface may also be set to be equal to or greater than the curvature of the second curved surface.

In addition, in other embodiments, the outer surface of the upper housing may be a flat surface, and the first positioning portion protrudes from the inner surface of the upper housing.

In the embodiment of the present disclosure, the lower housing 102 is provided with a stopper. The stopper is disposed at a sidewall position of the battery-portion recess 1024 away from the first positioning portion. The stopper, the battery-portion recess, and the first positioning portion cooperatively define a third positioning region for positioning a cylindrical surface of the battery portion.

As illustrated in the schematic view of the inner surface of the lower housing in FIG. 4, in a specific embodiment, in order to further limit the earphone, the stopper is further disposed on the lower housing 102. Specifically, the stopper 1025 is disposed at the sidewall of the battery-portion recess 1024 away from the first stopper. More specifically, the stopper 1025 has a plate-like structure extending towards the upper housing 101 from a position opposite to the sidewall that defines the V-shaped region 1026. That is, the stopper 1025 and the first stopper are respectively disposed at opposite sides of the battery-portion recess, and face each other. When the earphone is placed in the mounting recess and the earphone case is in a closed state, the stopper and the outer circumferential surface of the battery portion abut against each other, and a first support point is formed therebetween. The outer circumferential surface of the battery portion and the first positioning portion abut against each other, and a second support point is formed therebetween. A connecting line of the first support point and the second support point may be parallel to the upper surface of the body portion, or may obliquely extend towards the inner surface of the upper housing. In addition, a plane where the battery portion is in contact with the lowest end of the battery-portion recess is connected to both the first support point and the second support point, and the plane, the first support point, and the second support point together constitute a triangle. That is, the stopper, the battery-portion recess, and the first stopper cooperatively define the third positioning region for positioning the cylindrical surface of the battery portion. By providing the stopper in this embodiment, the limiting effect on the battery portion is further improved.

In a specific embodiment, the stopper 1025 extends from the sidewall of the battery-portion recess towards the inner surface of the upper housing, and an extending tail end of the stopper 1025 does not abut against the inner surface of the upper housing 101.

In another specific embodiment, the stopper 1025 extends from the sidewall of the battery-portion recess towards the inner surface of the upper housing, and the extending tail end of the stopper 1025 is flush with an axial cross-section of the battery portion.

In the above-mentioned embodiment, since the mounting recess includes the first mounting recess and the second mounting recess, two stoppers 1025 are provided on the lower housing 102. During use, when the earphone is mounted in the earphone case 100, the first positioning portion 1011 and the stopper 1025 respectively clamp both ends of the battery portion to limit the battery portion. In this embodiment, the limiting effect on the earphone in the horizontal direction is further improved.

In the embodiment of the present disclosure, in order to enhance the functionality of the stopper, the stopper is provided with a functional member. For example, the functional member may be a sensor or a charging contact. When in use, the sensor can detect whether the earphone is fitted in place, and the battery of the earphone can be charged through the charging contact.

In some specific embodiments, in order to better limit the body portion of the earphone, a first magnetic member is provided in the sound-emitting-portion recess 1021 or the connecting-member recess 1022. The body portion is magnetically attracted and secured to the first magnetic member. Of course, in order to better limit the body portion, the first magnetic member is provided in both the sound-emitting-portion recess 1021 and the connecting-member recess 1022, the sound-emitting-portion recess is magnetically attracted and secured to the first magnetic member in the sound-emitting-portion recess 1021, and the connecting member is magnetically attracted and secured to the first magnetic member in the connecting-member recess 1022.

It will be understood by those skilled in the art that in order to further limit the battery portion, a magnetic member is provided at an inner side of the stopper 1025, or a second magnetic member is provided in the battery-portion recess 1024, and the second magnetic member is magnetically connected to the battery portion to further limit the battery portion of the earphone.

In some specific embodiments, in order to further limit other components other than the battery portion in the horizontal direction, the upper housing 101 is provided with multiple first positioning portions 1011 on the inner surface of the upper housing 101. The multiple first positioning portions 1011 form multiple positioning points or positioning lines. The multiple first positioning portions 1011 are configured to limit the body portion or the ear hook of the earphone by means of point contact or line contact between the multiple positioning points or positioning lines and the body portion or the ear hook. Since the upper housing 101 in this embodiment is a transparent housing, the first positioning portion 1011 is also set as a transparent member. Therefore, the multiple first positioning portions 1011 on the upper housing can produce multiple magnifying glass effects, so that the user can more easily see the local structure of the earphone clearly.

In the above-mentioned embodiment, structures of multiple first positioning portions 1011 may be the same or different. For example, the first positioning portion 1011 may have a cylindrical structure, a hemispherical structure, or a plate-like structure.

It can be understood by those skilled in the art that in order to better limit the earphone, the first positioning portions 1011 may be symmetrically disposed at both sides of the body-portion recess or the ear-hook recess 1023.

In the embodiment provided by this embodiment, due to the joint cooperation of the first positioning portion, the second positioning portion, and the stopper, the earphone can be better limited in the accommodating cavity, thereby preventing the shifting of the earphone and avoiding affecting charging.

The above content provides a detailed description of the positioning structure inside the earphone case. The following will provide a detailed description of the structure of the earphone case.

As illustrated in the schematic view of the earphone case in FIG. 1, the earphone case of the present disclosure has a certain extension length, the upper housing 101 and the lower housing 102 are rotatably connected by a rotating shaft disposed along the first side-edge in the direction of extension length. The upper housing 101 and the lower housing 102 at the second side-edge opposite to the first side-edge constitute the opening and closing region. The upper housing 101 at the opening and closing region rotates about the rotating shaft to open or close the earphone case.

Both the outer surface of the upper housing 101 and the outer surface of the lower housing 102 at the opening and closing region in the embodiment of the present disclosure extend inwards to a joint surface to define a groove 103. In addition, the upper housing 101 and the lower housing 102 at the opening and closing region are provided with a snap-fit. When the upper housing 101 and the lower housing 102 are in a closed state, the upper housing 101 and the lower housing 102 are locked together by means of snap-in connection.

The upper housing 101 and the lower housing 102 have a certain thickness. The outer surfaces of the upper housing 101 and the lower housing 102 at the opening and closing region extend inwards to the joint surface, that is, the thickness of the upper housing 101 and the thickness of the lower housing 102 at the opening and closing region gradually decrease to define a recess. Of course, in other embodiments, the thicknesses of the upper housing 101 and the thickness of the lower housing 102 at the opening and closing region remain unchanged, but only the direction of extension is changed, that is, the sidewalls extend towards the accommodating cavity to define the groove 103.

During use, when the earphone case is to be closed, the upper housing 101 or the lower housing 102 is rotated about the rotating shaft to bring the upper housing 101 and the lower housing 102 together, and then the upper housing 101 and the lower housing 102 are locked in place by means of a snap-fit structure. When the earphone case is to be opened, the user simply places their hand at the groove 103 and applies a force to the upper housing 101 in a direction away from the lower housing 102 to release the snap-fit, after which the upper housing 101 can be rotated about the rotating shaft in a direction away from the lower housing 102 to open the earphone case.

In the earphone case provided in the present disclosure, the groove 103 is defined at the opening and closing region. The opening and closing region essentially refers to the sidewall at the side opposite to the rotating shaft. Moreover, since the earphone case of the present disclosure has a certain extension length, the extension length of the groove 103 also has a relatively long extension length. Therefore, during use, the user can place their hand on any region of the groove 103 to open the earphone case, so that the operation is more convenient.

In the embodiment of the present disclosure, a region where the groove is located is defined as an opening and closing portion. The opening and closing portion refers to a region between the farthest position to which the end of the upper housing 101 extends along the outer surface of the groove in a direction away from the accommodating cavity, and the farthest position to which the end of the lower housing 102 extends along the outer surface of the groove in a direction away from the accommodating cavity. An angle between a tangent line at an arbitrary position of the opening and closing portion or a connecting line of an arbitrary position of the opening and closing portion and the end portion and the joint surface is less than or equal to 90°.

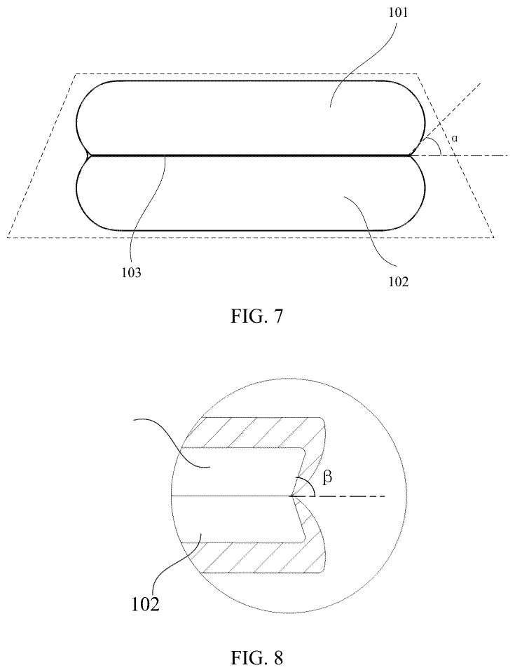

As illustrated in a left view of the earphone case in FIG. 6 and a right view of the earphone case in FIG. 7, in a specific implementation, there is an opening and closing portion at the opening and closing region. The opening and closing portion refers to a region where the groove is located, that is, a region outlined by a dashed box in FIG. 6. Specifically, the opening and closing portion refers to a region between the farthest position to which the end of the upper housing 101 extends along the outer surface of the sidewall of the upper housing 101 in a direction away from the accommodating cavity, and the farthest position to which the end of the lower housing 102 extends along the outer surface of the sidewall of the lower housing 102 in a direction away from the accommodating cavity. In this embodiment, the sidewalls of the upper housing 101 and the lower housing 102 at the opening and closing portion position are inclined or curved surfaces. When the sidewall at the opening and closing portion is an inclined surface, an angle between the inclined surface and an extension line of the joint surface in the direction away from the accommodating cavity is less than or equal to 90°.

When the sidewall at the opening and closing portion is a curved surface, an angle between a tangent line at an arbitrary position of the curved surface or a connecting line of an arbitrary position of the curved surface and the end portion and the extension line of the joint surface away from the accommodating cavity is a, where a is less than or equal to 90°. In this embodiment, the angle between the tangent line at the extreme value of the outer surface of the sidewall and the joint surface is 90°, and the angle between the tangent line at any other positions and the extension line of the joint surface in the direction away from the accommodating cavity is less than 90°.

In the embodiment of the present disclosure, the outer surfaces of the sidewalls of the upper housing 101 and the lower housing 102 at the opening and closing region are curved, and are connected to the outer top surfaces of the upper housing 101 and the lower housing 102 in a curved transition, respectively. The groove is defined by splicing a curved surface of the sidewall of the first housing and a curved surface of the sidewall of the second housing that are adjacent to each other. The outer surface contours of the upper housing and the lower housing are mirror-symmetrical at side-edge end portions. An inner surface of the top wall of the upper housing is parallel to the joint surface, and an inner surface of the sidewall is perpendicular to an inner surface of the top wall. A vertical distance between a region of the outer surface of the sidewall of the upper housing 101 that is farthest from the accommodating cavity and a plane on which the joint surface is located ranges from 3 mm to 5 mm, and the radius of the curve ranges from 5 mm to 6 mm.

In the above-mentioned embodiment, the outer surfaces of the upper housing 101 and the lower housing 102 are symmetrically disposed at side-edge end portions, and the outer surface of the sidewall at the opening and closing region is curved. The groove is defined by the outer surfaces of the curved sidewalls extending towards the accommodating cavity. A vertical distance between the highest point of the curved outer surface and the plane on which the joint surface is located ranges from 3 mm to 5 mm, and the radius of the curve ranges from 5 mm to 6 mm.

In a specific implementation, the vertical distance between the highest point of the curved outer surface of the sidewall of the upper housing and the plane on which the joint surface is located is 4 mm, and the radius of the curve is 5.3 mm. Of course, in other embodiments, the vertical distance between the highest point of the curved outer surface of the sidewall of the upper housing and the plane on which the joint surface is located may be any value from 3 to 5 mm, and the radius of the curve may be any value from 5 to 6 mm. The depth of the groove at the opening and closing region ranges from 1.5 mm to 3 mm, such as 1.8 mm. In this embodiment, the depth of the groove refers to the depth to which the curved surface extends towards the accommodating cavity to the joint surface.

In the embodiment of the present disclosure, the curved peripheral walls of the upper housing and the lower housing are configured to according to the above-mentioned data, so that the curved surface of the earphone case is not only be more beautiful, but also the depth of the groove at the opening and closing region is more suitable for fingers of the user to reach in. As the fingers enter the groove, pressure can be applied to the upper housing and the lower housing, so that the earphone case can be opened with one hand.

In this embodiment, at least part of the inner surfaces of the top walls of the upper housing 101 and the lower housing 102 that are connected to the sidewall at the opening and closing region are flat surfaces, and the flat surfaces are parallel to the joint surface. The outer surface of the top wall is connected to the outer surface of the sidewall in a curved transition. The inner surface of the top wall is perpendicular to the inner surface of the sidewall, and the inner surface of the top wall is connected to the inner surface of the sidewall in a curved transition.

In this embodiment, since the inner surface of the top wall is horizontal, and the inner surface of the sidewall is perpendicular to the inner surface of the top wall, that is, the inner surface of the sidewall is vertical. This structural configuration facilitates demolding during actual production, thereby improving production efficiency. In addition, the groove 103 is cooperatively defined by the outer surfaces of the upper housing 101 and the lower housing 102, and the depth of the groove 103 is relatively large, so that the user can more easily position the groove 103, and the user can also open the earphone case with one hand. This embodiment can improve the user experience.

In another specific embodiment, the case further has a third side-edge and a fourth side-edge at both ends of the case. The opening and closing region extend from the second side-edge to the third side-edge and the fourth side-edge. In other words, in this embodiment, except that the sidewall of the case at one side where the rotating shaft is located is not curved, the other three peripheral walls are curved, that is, the second side-edge, the third side-edge, and the fourth side-edge all serve as the opening and closing region, and the user can also open the case at the opening and closing region of the third side-edge and the opening and closing region of the fourth side-edge. On the basis of the foregoing, it can be understood by those skilled in the art that the opening and closing region may also be provided on the second side-edge and the third side-edge, or on the second side-edge and the fourth side-edge.

In another specific embodiment, the outer surface of the upper housing 101 and the outer surface of the lower housing 102 are symmetrically disposed at the side-edge end portions, and the outer surfaces of the upper housing 101 and the lower housing 102 are both curved. In other words, in this embodiment, the outer surfaces of the peripheral walls of the upper housing 101 and the lower housing 102 are symmetrically arranged in a curved shape, so that the groove 103 cannot only be defined by the upper housing 101 and the lower housing 102 at the opening and closing region, but also can be defined in positions where the four peripheral walls of the upper housing 101 and the lower housing 102 abut against each other.

In the above-mentioned embodiment, the first housing is a transparent housing or a translucent housing, and the outer surfaces of the first housing and the second housing are symmetrically arranged, that is, the outer surface contours of the first housing and the second housing are mirror-symmetrical at the side-edge portions. In addition, the outer surfaces of the case of the present disclosure at connections between all sidewalls and the top wall are smooth curved surfaces, that is, there are no sharp edges and corners on the outer surfaces of the case, the connections between sidewalls, as well as the sidewalls and the top wall, are all configured in a curved shape. Thus, the case can be conveniently placed in a narrow space such as a pocket of clothes. When the case is placed in the pocket, due to the curved surface transition of the case, a part of the pocket in contact with the case does not have obvious edges, and the pocket tends to bulge into a trapezoidal-like shape (e.g., the trapezoid outlined by a dashed box in FIG. 7). The curved surface can help minimize the trapezoid formed by the case supporting the pocket, so that the volume is smaller in somatosensory.

In addition, this configuration can prevent the edges on the outer surface of the case from colliding with other articles when the case and other articles are placed together in the storage device, thereby avoiding damage to the outer surface of the case.

In the embodiment of the present disclosure, the case is molded by injection molding or the like, and the manufacturing method can reduce stress concentration at the outer edge of the case.

In the above-mentioned embodiment, the upper housing is a transparent housing or a translucent housing, and the outer surfaces of the upper housing and the lower housing are symmetrically arranged, that is, the outer surface contours of the upper housing and the lower housing are mirror-symmetrical at the side-edge portions. In addition, the outer surfaces of the earphone case of the present disclosure at connections between all sidewalls and the top wall are smooth curved surfaces, that is, there are no sharp edges and corners on the outer surfaces of the earphone case, the connections between sidewalls, as well as the sidewalls and the top wall, are all configured in a curved shape. This configuration can prevent the edges and corners on the outer surface of the earphone case from colliding with other articles when the earphone case and other articles are placed together in the storage device, thereby avoiding damage to the outer surfaces of other articles. Moreover, the curved design enhances the aesthetic appearance of the earphone case.

In another specific embodiment, the opening and closing region and side parts of the two ends of earphone case connected to the opening and closing region both define grooves 103, except that the sidewall of the first side-edge where the rotating shaft is located does not define the groove 103. This this configuration, the user can position the opening and closing region more quickly by touch, thereby enabling faster opening or closing of the earphone case.

In the embodiment of the present disclosure, the inner surface of the sidewall of the upper housing 101 is a smooth annular cylindrical surface that is closed or not closed. Alternatively, the inner surface of the sidewall of the upper housing 101 is a smooth annular inclined surface that is closed or not closed, the inclined surface extends obliquely from an end portion of the inner surface of the sidewall of the upper housing to the top surface of the upper housing, and an angle between the inclined surface and the joint surface is an acute angle. Alternatively, the inner surface of the sidewall of the upper housing 101 is a smooth curved surface that is closed or not closed, and the curvature of the curved surface is consistent with the curvature of the outer surface of the upper housing.

In a specific embodiment, the outer surface of the sidewall of the upper housing 101 is curved, the inner surface of the sidewall of the upper housing is vertically disposed, the inner surface of the sidewall of the upper housing is perpendicular to the inner surface of the top wall of the upper housing 101, and the connection between the inner surface of the sidewall and the inner surface of the top wall is curved transitional connection. In this embodiment, the upper housing 101 has four sidewalls, and the connection between the inner surface of the top wall and each of the inner surfaces of the four sidewalls is a curved transitional connection. When the inner surfaces of the sidewalls do not need to avoid the rotating shaft, the inner surfaces of the four sidewalls of the upper housing 101 form a smooth closed annular cylindrical surface. When the inner surfaces of the sidewalls need to avoid the rotating shaft, the inner surfaces of the four sidewalls of the upper housing form an unclosed annular cylindrical surface.

In the above-mentioned embodiment, the upper housing 101 of the earphone case is a transparent housing or a translucent housing, so that the user can observe the state of the object contained in the accommodating cavity through the upper housing 101 without opening the earphone case. In addition, since the outer surface of the sidewall of the upper housing 101 is curved, this configuration increases the thickness of the case, making the first housing 101 more robust, capable of withstanding greater pressure from the top surface or side surface of the housing, and also improving the drop resistance performance.

On the basis that the outer surface of the sidewall of the upper housing 101 is curved, the inner surface of sidewall of the upper housing is vertically arranged, so that the outer surface and the inner surface of the sidewall form a plano-convex lens. The plano-convex lens is capable of magnifying the object contained in the earphone case and providing the user with a clearer visual effect. In addition, when the sidewalls of the upper housing at the first side-edge and the second side-edge both form plano-convex lenses, a complex visual effect can be achieved.

As illustrated in a schematic view of FIG. 8 in which the inner surface of the sidewall of the upper housing is inclined, in another specific embodiment, the inner surface of the sidewall of the upper housing 101 is not vertically disposed, but is inclined. Specifically, the inner surface of the upper housing 101 extends obliquely from the end of the inner surface of the upper housing 101 at the opening of the upper housing 101 to the top surface of the upper housing 101 in a direction away from the central axis of the accommodating cavity. An angle between the inclined surface and the extension line of the joint surface in the direction away from the accommodating cavity is 8, where 8 is an acute angle. Of course, in this embodiment, the curved transitional connections are also provided between the inner surfaces of the sidewalls as well as between the inner surfaces of the sidewalls and the inner surface of the top wall. When the inner surfaces of the sidewalls do not need to avoid the rotating shaft, the inner surfaces of the four sidewalls of the upper housing 101 form a smooth closed annular inclined surface. When the inner surfaces of the sidewalls need to avoid the rotating shaft, the inner surfaces of the four sidewalls form an unclosed annular inclined surface. It is worth noting that FIG. 8 is merely a schematic view provided to illustrate the condition in which the inner surface of the sidewall of the upper housing 101 is inclined.

In another specific embodiment, the inner surface of the sidewall of the upper housing 101 is neither vertically nor inclined, but is curved, and the curvature of the curved inner surface of the sidewall is the same as the curvature of the outer surface of the sidewall. In other words, in this embodiment, the inner surface and the outer surface of the sidewall of the upper housing have the same shape and the same bending direction of the curve. Therefore, when the inner surfaces of the sidewalls do not need to avoid the rotating shaft, the inner surfaces of the four sidewalls of the upper housing 101 form a smooth closed annular curved surface. When the inner surfaces of the sidewalls need to avoid the rotating shaft, the inner surfaces of the four sidewalls form an unclosed annular curved surface.

In the embodiment of the present disclosure, in order for the user to distinguish the first side-edge and the second side-edge only by touch, the groove may be defined only at the second side-edge where the opening and closing region is located, while the groove may not be defined at the first side-edge where the rotating shaft is located. When both the first side-edge and the second side-edge define grooves, in order to allow the user to locate the opening and closing region by touch, different materials may be used for the outer surface at the opening and closing region and the outer surface at the rotating shaft during manufacturing. Alternatively, the outer surface at the opening and closing region and the outer surface at the rotating shaft may be made in different shapes.

The earphone case provided in the present disclosure differs from the conventional earphone case in that the groove 103 is no longer defined only at the middle region where the housings abut against each other at the second side-edge, but is defined across the region where the housings abut against each other at the second side-edge. The region occupied by the groove on the earphone case is increased, so that the user can open the earphone case by applying force at different positions, thereby make the operation more convenient.

In the embodiment of the present disclosure, when the upper housing of the earphone case is a transparent housing, and the outer surface and the inner surface of the upper housing are curved surfaces, the curved surfaces cause light to be refracted at different angles, so that the object inside the earphone case may visually appear magnified, reduced, or distorted. In the embodiment of the present disclosure, the earphone case is designed, by utilizing a phenomenon whereby curved surfaces cause light to be refracted at different angels to achieve unique visual effects, the earphone case is designed.

Those skilled in the art can understand that when the thickness of the sidewall of the upper housing of the earphone case remains unchanged and the sidewall of the upper housing is perpendicular to the top surface, although light will be refracted as the light enters the upper housing from the air, an refraction angle is not large. In other words, the visual distortion of the earphone is not large, and the user can still clearly see the shape and position of the earphone through the transparent upper housing.

When the earphone is placed in the mounting recess, since distances between various parts of the earphone and the sidewall of the upper housing are different, a unique light and shadow effect will be created through the curved surface of the sidewall of the upper housing. For example, when the user looks in a direction from the opening and closing region of the upper housing towards the rotating shaft, a part of the earphone may disappear or be visually distorted due to refraction, thereby creating a unique visual effect.

The outer surface of the sidewall of the upper housing of the earphone case in the present disclosure is a curved shape, and the inner surface is a vertical structure perpendicular to the top surface, so that the inner surface and the outer surface of the first sidewall form a plano-convex lens. When designing the plano-convex lens, it is necessary to consider the relative position of various parts of the earphone and the upper housing, so that some regions of the earphone form a clear imaging effect close to a focus of the lens, and regions of the earphone form a blurred imaging effect far away from the focus. Therefore, the earphone can exhibit a visual transition between clarity and blur, thereby enhancing the visual depth.

Based on the characteristics of the plano-convex lens described above, important parts of the earphone can be disposed close to the focus and less important parts of the earphone can be disposed away from the focus. For example, since the charging contact of the earphone is usually disposed on the body portion of the earphone, the body portion can be disposed close to the focus, so that the user can clearly see the shape and position of the body portion through the upper housing.

In addition, since the outer surface of the upper housing is a curved surface, a more obvious lens effect and light-converging function can be achieved even with a very low sidewall height, so that the corresponding region appears brighter. Therefore, for regions where enhanced visual effects are desired, such as edges or specific angles, the lens effect can be achieved by designing the variation of the curvature of the outer surface of the housing and the thickness of the inner surface. Therefore, it is ensured that these regions are designed to concentrate light, so that specific parts of the upper housing appear brighter, thereby adding overall visual appeal.

In the embodiment provided by the present disclosure, in order to make the upper housing have a specific visual effect, before manufacturing the upper housing, the influence of different curvatures and wall thicknesses on light is simulated by means of computer simulation. Based on the simulation results, the design is optimized, parameters such as curvature and wall thickness of the upper housing required to achieve the visual effect are determined, and then the upper housing is manufactured according to the determined parameters.

In some embodiments of the present disclosure, an earphone adapted to the earphone case is further provided.

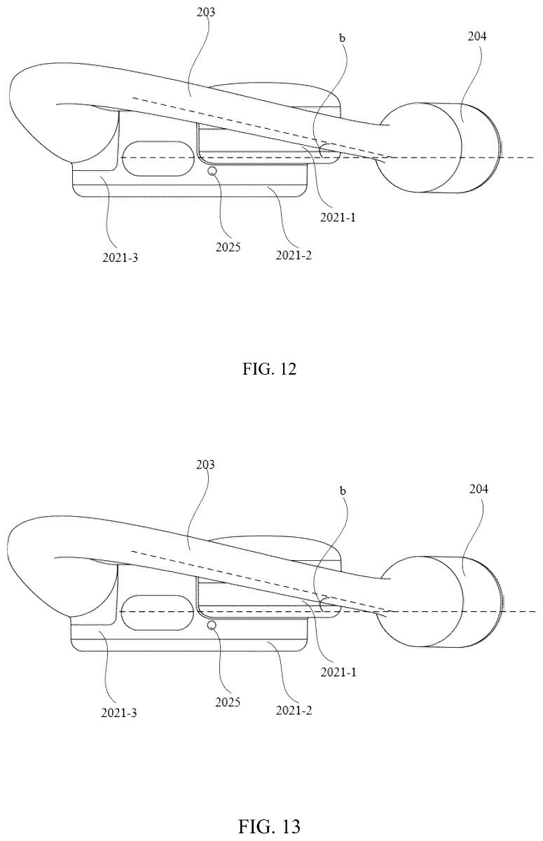

As illustrated in a bottom view of the earphone in FIG. 12, the earphone in this embodiment is an open-type earphone 200, which includes a body portion, an ear hook 203, and a battery portion 204 that are connected in sequence. Specifically, the body portion includes a sound-emitting portion 201 and a connecting member 202. A housing of the sound-emitting portion 201 is a cylinder. A sound outlet hole for sound output is defined on an end surface of the cylinder facing towards the human ear. The connecting member 202 has a long strip-shaped structure with a certain thickness. One end of the connecting member 202 is connected to the sound-emitting portion 201, and the other end of the connecting member 202 is connected to one end of the ear hook 203. More specifically, the sound-emitting portion 201 has a lower surface facing towards an ear canal and an upper surface facing away from the ear canal. The connecting member 202 has a lower surface facing towards the ear canal and an upper surface facing away from the ear canal. An end portion of the connecting member 202 is at least connected to a peripheral wall at the upper surface of the sound-emitting portion 201, and the lower surface of the sound-emitting portion 201 exceeds the lower surface of the connecting member 202. That is, there is a height difference between the lower surface of the connecting member 202 and the lower surface of the sound-emitting portion 201, so that a step portion is formed between the lower surface of the connecting member and the lower surface of the sound-emitting portion 201.

When the earphone is placed in the earphone case, the sound-emitting portion, the connecting member, the ear hook, and the battery portion of the earphone are correspondingly placed in the sound-emitting-portion recess, the connecting-member recess, ear-hook recess, and the battery-portion recess. Since the depths of the sound-emitting-portion recess, the connecting-member recess, the ear-hook recess, and the battery-portion recess are different, when the earphone is placed in the mounting recess, a part of the earphone is completely arranged in the mounting recess, and the other part of the earphone exceeds the mounting recess.

In the embodiment of the present disclosure, at least the connecting member and the battery portion of the earphone respectively exceed the connecting-member recess and the battery-portion recess. In addition, the top surface of the connecting member far away from the mounting recess is a flat surface, and the battery portion has a cylindrical structure. Therefore, when the earphone is placed in the earphone case, and the upper housing and the lower housing of the earphone case are in a closed state, the inner surface of the upper housing abuts against or spaced apart from the top surface of the connecting member of the earphone with a distance ranging from 0.2 mm to 0.5 mm, to limit the connecting member. When the earphone is placed in the earphone case, and the upper housing and the lower housing of the earphone case are in a closed state, the outer surface of the first positioning portion of the upper housing is tangent to the outer surface of the battery portion, or the distance between the outer surface of the first positioning portion and the outer surface of the battery portion ranges from 0.2 mm to 0.5 mm, to limit the battery portion. In other words, when the earphone is placed in the earphone case, the first positioning portion and the inner surface of the upper housing of the earphone case together cooperate with the mounting recess to limit the earphone in the accommodating cavity of the earphone case, so as to prevent the earphone from shifting along with the shaking of the earphone case and avoid affecting charging.

In the embodiment of the present disclosure, the sound-emitting portion of the earphone is provided with a magnet that corresponds to the first magnetic member, so that the magnet on the sound-emitting portion cooperates with the first magnetic member in the sound-emitting-portion recess to better limit the sound-emitting portion in the sound-emitting-portion recess. When the first magnetic member is disposed at the bottom of the sound-emitting-portion recess, the magnet is disposed at the lower surface of the sound-emitting portion. When the first magnetic member is disposed at the peripheral wall of the sound-emitting-portion recess, the magnet is disposed at the peripheral wall of the sound-emitting portion.

Those skilled in the art can understand that, when the first magnetic member is disposed in the connecting-member recess, the magnet corresponding to the first magnetic member is provided on the connecting member. When the first magnetic member is disposed in each of the sound-emitting-portion recess and the connecting-member recess, the magnet is correspondingly provided on each of the sound-emitting portion and the connecting member of the earphone.

The above-mentioned embodiments describe the earphone and the state of the earphone when placed in the earphone case. To facilitate a better understanding of the embodiments of the present disclosure, a detailed description of the structure of the human ear and the positional relationship between the various components of the earphone and the human ear when the earphone is worn will be provided below.

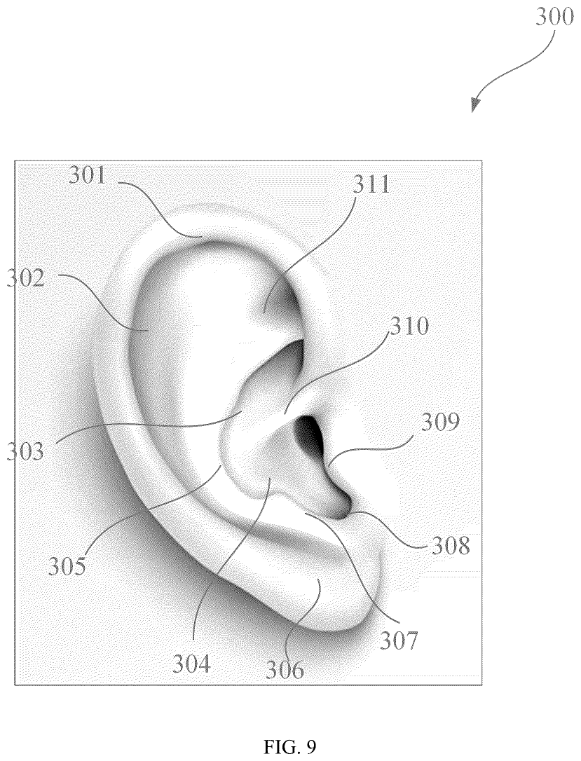

Specifically, as illustrated in a schematic structural view of a human ear of FIG. 9, an externally visible region of a human ear 300 includes a helix 301, a scaphe 302, a cymba of auricular concha 303, a cavity of auricular concha 304, an antihelix 305, an earlobe 306, an antitragus 307, an intertragus notch 308, a tragus 309, a crus of helix 310, and a triangular fossa 311. In some embodiments, the earphone can be supported by one or more parts of the human ear to achieve stable wearing of the earphone.

In some embodiments, since the cavity of auricular concha 304, the antihelix 305, the triangular fossa 311, and the like all have a certain depth and volume in three-dimensional space, the cavity of auricular concha 304, the antihelix 305, and the triangular fossa 311 can all be used to accommodate the sound-emitting portion, thereby meeting the requirements for wearing the earphone.

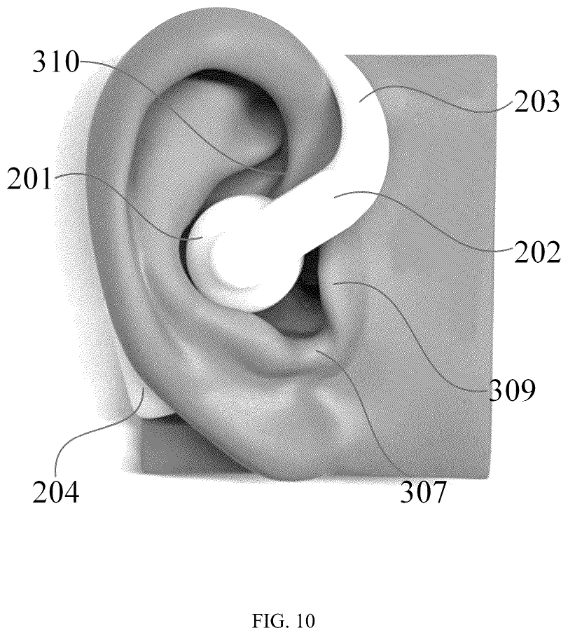

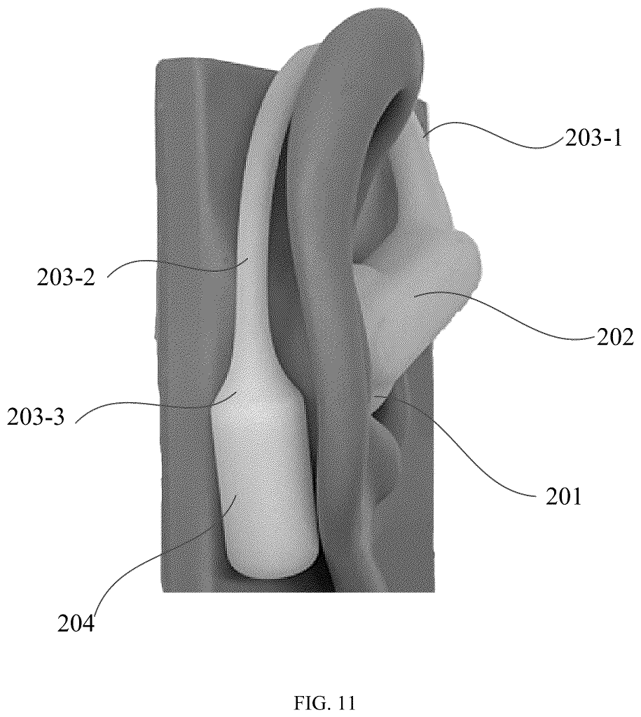

As illustrated in FIG. 10 and FIG. 11, which are schematic views of an earphone worn on a human ear model, in the embodiment of the present disclosure, the sound-emitting portion is located in the cavity of auricular concha.

In a specific implementation, when the earphone is worn on the human ear through the ear hook 203, since there is the step portion at the connection between the sound-emitting portion and the connecting member, a part of the sound-emitting portion can extend deeper into the cavity of auricular concha. A free end of the sound-emitting portion and the human ear form a first support region. The ear hook forms a suspension point on an upper part of the human ear. The battery portion and a rear part of the human ear form a third support region. The earphone is secured in the vertical direction by the suspension point, and clamps the human ear in the horizontal direction by the first support region and the third support region. The triangle formed by connecting the first support region, the suspension point, and the third support region can stably secure the earphone at the relative position of the human ear. In this embodiment, the free end of the sound-emitting portion refers to an end portion of the sound-emitting portion away from the connection of the sound-emitting portion and the connecting member. The first support region refers to a region in which the lower surface of the sound-emitting portion abuts against a bottom wall of the cavity of auricular concha, and a region in which the peripheral wall of the sound-emitting portion at the free end of the sound-emitting portion abuts against the peripheral wall of the cavity of auricular concha.

In the above-mentioned embodiment, all three regions where the earphone is in contact with the human ear are designed with smooth transitions, and the curvature of each of the three regions is similar to the curvature of the human ear itself, so that the sensation of a foreign object during in a wearing state can be reduced, enabling an almost imperceptible wearing experience.

In some embodiments, a contact area between the earphone and the human ear is relatively small, typically in the form of a point contact, a line contact, or a small surface contact. In addition, due to design of profile modeling of the earphone itself, the earphone can be stably and securely worn on the human ear by applying a clamping force to the ear, and the regions where the clamping force is applied to the ear can be reduced, thereby improving the wearing experience of the user.

More specifically, a part of the sound-emitting portion 201 exceeding the connecting member 202 is located in the cavity of auricular concha 304. The connecting member 202 extends obliquely upward through a region between the tragus 309 and the crus of helix 310 of the human ear. Since the region between the tragus 309 and the helix foot 310 is a recessed, the connecting member 202 can avoid the tragus, so that the lower surface of the sound-emitting portion abuts against at least part of the bottom wall of the cavity of auricular concha, and the two tend to be arranged in parallel. During use, even when the head of the user moves, the sound-emitting portion 201 can be limited in the cavity of auricular concha, so that a sound-emitting hole on the sound-emitting portion can be aligned with the ear canal. This embodiment can effectively prevent the sound-emitting portion from moving and avoid sound leakage, thereby providing the user with a better auditory experience.

As illustrated in a perspective view of the earphone in FIG. 16, in the embodiment of the present disclosure, when the earphone is in a wearing state, the connecting member extends obliquely upward from an end of the connecting member connected to the sound-emitting portion to an end of the connecting member connected to the ear hook. Specifically, there is an angle a between the connecting member and a parallel line of a vertical axis of the human body, where the value of a ranges from 45° to 60°. In this embodiment, the vertical axis of the human body refers to a line that passes through the center of the human body in the height direction of the human body and is perpendicular to the ground when the human stands on a horizontal ground. The parallel line of the vertical axis of the human body refers to a straight line that passes through the center of the upper surface of the sound-emitting portion.

In the above-mentioned embodiment, there is an angle between the connecting member and the parallel line of the vertical axis of the human body, so that the connecting member 201 can pass through the region between the tragus 309 and the crus of helix 310. This configuration allows the connecting member to avoid a part of the tragus, enabling the ear hook to be worn more securely.

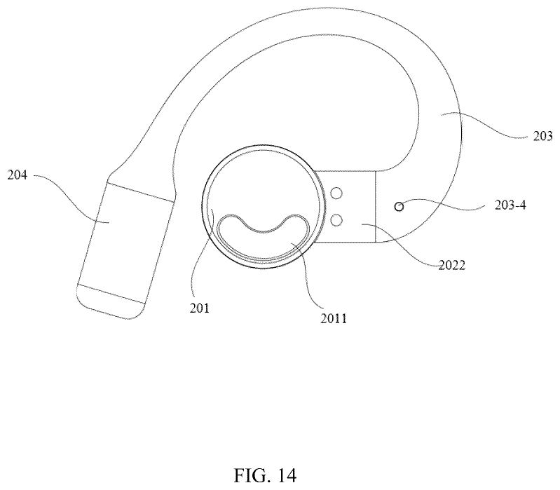

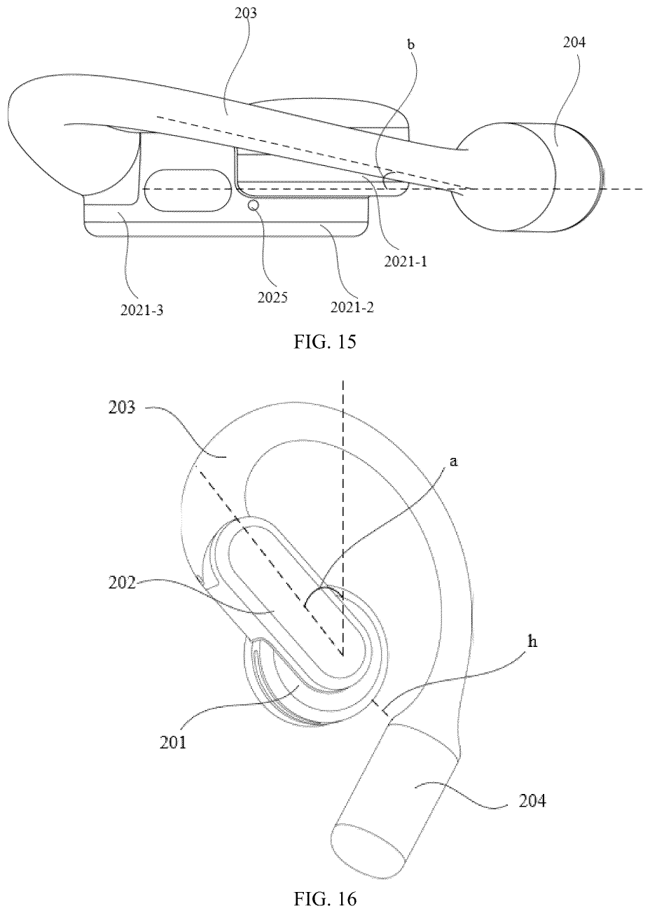

As illustrated in FIG. 12 to FIG. 14, in the embodiment of the present disclosure, the transparent housing or the translucent housing of the connecting member 202 cooperatively a receiving cavity. The receiving cavity is provided with an electronic component therein. The housing covers a part of the peripheral wall of the sound-emitting portion 201.

In the above-mentioned embodiment, the transparent housing or the translucent housing of the connecting member 202 cooperatively the receiving cavity, and the electronic component is disposed in the receiving cavity. The housing includes a first housing 2021 and a second housing 2022. The first housing 2021 includes a first part 2021-1, a second part 2021-2, and a third part 2021-3 that are integrally formed. The first part 2021-1 has a cylindrical semi-surrounding structure, which covers a part of the peripheral wall and a part of the upper surface of the sound-emitting portion 201. Specifically, the semi-surrounding structure defines an opening at an end portion of the semi-enclosing structure facing towards the ear hook 203, and defines a hollow portion at both a central region of the semi-surrounding structure and a region extending from the central region towards an end portion of the ear hook 203. The second part 2021-2 covers the hollow portion of the first part 2021-1, and exceeds a top surface of the first part 2021-1, where the top surface of the first part 2021-1 refers to a surface of the first part 2021-1 away from the ear canal. The third part 2021-3 is disposed between the sound-emitting portion 201 and the ear hook 203. One end of the third part 2021-3 is connected to the first part 2021-1 at the opening of the first part 2021-1, and the other end of the third part 2021-3 abuts against or is fixed and connected to the ear hook 203. The third part 2021-3 has three sidewalls in a circumferential direction of the third part 2021-3, namely, an upper sidewall facing away from the human ear, a right sidewall facing towards the ear hook 203, and a left sidewall opposite to the right sidewall. The third part and the second housing cooperatively form a sleeve structure.

In the above-mentioned embodiment, a direction in which the connecting member is close to or away from the human ear is the thickness direction, an extension direction of both end portions of the connecting member is the length direction, and a connection direction of the left sidewall and the right sidewall is a width direction. In this embodiment, the width of the connecting member 202 is smaller than the diameter of the upper surface of the sound-emitting portion 201. In other words, the width of the second part 2021-2 is smaller than the diameter of the upper surface of the sound-emitting portion 201. In this embodiment, the volume of the connecting member 202 is smaller, so that the earphone 200 does not cover the human ear in a large area, thereby avoiding the covered part of the human ear from sweating and avoiding affecting the user experience.

In the embodiment of the present disclosure, the sound-emitting portion 201 includes two parts, one part is a protruding part that protrudes from the connecting member 202, and the other part is a part covered by the first part. An area of an end surface of the part of sound-emitting portion 201 covered by the first part is smaller than an area of an end surface of the protruding part of the sound-emitting portion 201. A circular shape surrounded by an end portion of the first part is the same size as a circular shape of the end surface of the protruding part. In other words, when the first part covers the sound-emitting portion 201, a housing of the protruding part of the sound-emitting portion 201 and the first part constitute a cylinder as a whole. Of course, in other implementations, areas of end surfaces of both parts of the sound-emitting portion may be the same.

In the embodiment of the present disclosure, in order to more conveniently issue a control instruction to the earphone, a pressure sensor is provided on an inner surface of the sidewall of the third part 2021-3. During use, the user presses the sidewall where the pressure sensor is located, and after the pressure sensor receives a signal, the pressure sensor issues a control instruction corresponding to the signal to the earphone 200. After the earphone 200 receives the control instruction, the earphone 200 performs an operation corresponding to the control instruction.

It can be understood by those skilled in the art that the pressure sensor may be provided on an inner surface of any one or more of the upper sidewall, the left sidewall, and the right sidewall of the third part. For example, when one pressure sensor is provided, the pressure sensor may be independently disposed on the inner surface of either the right sidewall, the right sidewall, or the upper sidewall. For example, when two pressure sensors need to be provided, the two pressure sensors are typically disposed on the inner surfaces of the right sidewall and the upper sidewall, or the inner surfaces of the left sidewall and the upper sidewall, so as to avoid the two pressure sensors from being disposed on the left sidewall and right sidewall that are opposite to each other, thereby preventing unintended activation of the other sensor when issuing an instruction to one sensor.

In the embodiment of the present disclosure, the body portion includes the sound-emitting portion and the connecting member. When the earphone is placed in the earphone case, the connecting member is located above the sound-emitting portion. The connecting member has a rectangular structure, which is easier to take than the cylindrical structure of the battery portion. When the user takes the earphone, the user is guided to position the hand at the connecting member, and then the earphone is taken from the earphone case by grabbing the sidewalls of the connecting member, thereby establishing a consistent take-up mode.

In the embodiment provided by the present disclosure, the sound-emitting portion 201 and the ear hook 203 may be directly connected by the connecting member 202, or may be connected by a fixing member inside the connecting member 202.

In a specific embodiment, the end portion of the ear hook 203 connected to the connecting member 202 defines a curved groove extending away from the sound-emitting portion 201, and the first housing has a connecting portion extending towards the end portion of the ear hook 203. Specifically, an upper sidewall of the third part vertically towards the second housing, and an extending tail end of the upper sidewall of the third part extends parallel to a direction from the second housing towards the ear hook 203, so as to form the connecting portion of the first housing. The second housing has a connecting portion extending towards the end portion of the ear hook 203. The connecting member 202 is connected to the ear hook 203 by inserting the end portion of the first housing and the end portion of the second housing into the curved groove of the ear hook 203.

On the basis of the above-mentioned embodiment, it can be understood by those skilled in the art that the second housing is fixed and connected to the third part, and the connecting member can still be connected to the ear hook only by connecting the second housing or the third part to the ear hook.

In the above-mentioned embodiment, in order to fasten the connection between the sound-emitting portion and the ear hook, a fastener is provided at the connection between the sound-emitting portion and the ear hook. The fastener sequentially passes through a fastening hole 203-4 on the ear hook, and the connecting portion of the third part and the connecting portion of the second housing, to fixedly connect the ear hook, the connecting portion of the third part, and the connecting portion. Alternatively, the fastener sequentially passes through the fastening hole 203-4 on the ear hook and the connecting portion of the third part, to fixedly connect the ear hook and the connecting portion of the third part. Alternatively, the fastener sequentially passes through the fastening hole 203-4 on the ear hook and the connecting portion of the second housing, to fixedly connect the ear hook and the connecting portion of the second housing. This embodiment can reduce the amount of glue and avoid affecting the appearance of the connecting member 202. In particular, when the connecting member is transparent/translucent, glue overflow is reduced inside the connecting member 202 or at the joint between the connecting member 202 and the ear hook 203, and the appearance effect can be significantly optimized.

In order to provide the user with a better wearing experience, when the sound-emitting portion 201 is inserted into a region of the cavity of auricular concha, the outer periphery of the sound-emitting portion 201 is preferably kept from abutting against the helix, the antitragus, and tragus. Therefore, in this embodiment, the diameter of the lower surface of the sound-emitting portion 201 is set to be smaller than the diameter of a circle that is tangent to all of the helix, the antitragus, and tragus. In some specific embodiments, the diameter of the lower surface of the sound-emitting portion 201 ranges from 14 mm to 16.5 mm, so that the diameter of the lower surface of the sound-emitting portion 201 can fit the average value of the upper cavity of auricular concha of the human ear.

In the above-mentioned embodiment, the sound-emitting portion 201 and the connecting member 202 are described. The following provides a detailed description of the ear hook 203 and the battery portion 204.

In the embodiment of the present disclosure, the function of the ear hook 203 is to secure the earphone 200 onto the human ear, so the ear hook 203 has a curved structure adapted to the outer contour of the human ear. Specifically, the ear hook 203 extends from the end portion of the ear hook 203 connected to the third part, first obliquely towards the right sidewall of the third part, and then further extends towards an end portion of the sound-emitting portion 201 away from the connecting member 202. An extending tail end of the ear hook 203 is located near the end portion of the sound-emitting portion 201, and is connected to the battery portion 204. In this embodiment, the ear hook 203 may include three continuous bending segments, namely, a first bending segment, a second bending segment, and a third bending segment. Specifically, the first bending segment begins at the end portion of the ear hook 203 connected to the connecting member 202, and extends towards the right sidewall of the third part. The second bending segment follows the first bending segment and extends substantially towards the right sidewall of the third part. The third bending segment follows the second bending segment and obliquely extends to the position near the end portion of the sound-emitting portion 201 away from the connecting member 202. As an example, the radius of curvature of the first bending segment is the smallest, the radius of curvature of the second bending segment is larger, and the radius of curvature of the third bending segment is the largest. This gradual curvature design allows the ear hook 203 to better conform to the shape of the outer contour of the human ear.

As illustrated in a front view of the earphone in FIG. 13, the function of the ear hook 203 is to secure the earphone 200 onto the human ear. The human ear usually extends outwards obliquely relative to the side surface of the head, defining an angle between the human ear and the head. In order to better adapt to the human ear, the ear hook 203 in this embodiment first extends obliquely below the lower surface of the sound-emitting portion 201, and then extends obliquely towards the upper surface of the sound-emitting portion 201, and the extending tail end of the ear hook 203 is slightly higher than an upper end surface of the first part or is flush with an upper end wall of the first part. Given that the angle between the human ear and the head ranges from 25° to 30°, in order to fit the ear hook in this embodiment to the human ear better, an angle b is defined between the middle part of the ear hook and a connecting line of two ends of the ear hook. In one specific embodiment, the angle b is 30°.

In the above-mentioned embodiment, the diameter of the ear hook 203 varies from a connection point of the ear hook 203 and the sound-emitting portion 201 to a connection point of the ear hook 203 and the battery portion 204. The ear hook 203 has a substantially cylindrical structure as a whole, and sequentially includes a first variable diameter segment 203-1, a diameter segment 203-2, and a second variable diameter segment 203-3. The first variable diameter segment 203-1 refers to a region of the ear hook 203 from a connection of the ear hook and the sound-emitting portion to a top end of the ear hook, and the diameter of the ear hook in this region gradually decreases. The second variable diameter segment 203-3 refers to an end portion of the ear hook 203 connected to the battery portion 204. The second variable diameter segment 203-3 has a flared shape. In the second variable diameter segment 203-3, the diameter of the ear hook rapidly increases from small to large, and the ear hook is connected to the battery portion at a position where the second variable diameter segment 203-3 has the maximum diameter. The diameter segment 203-2 is located between the first variable diameter segment and the second variable diameter segment.

When the earphone 200 is in a wearing state, the first variable diameter segment 203-1 is located at a region from the front side of the human ear to an upper auricle, the diameter section 203-2 is located at the middle region of the rear of the human ear, and the second variable diameter segment 203-3 is located at the middle and lower region of the rear of the human ear. In this embodiment, a starting position of the first variable diameter segment is the connection of the ear hook 203 the connecting member 202, and an end position of the first variable diameter segment is the top end of the ear hook 204, which is the top end of the human ear and the areas in front and back of the top end. That is, the top refers to a certain area extending forward and rearward at the hanging point of the ear hook and the upper portion of the human ear. In the present aspect, as the inner diameter of the first variable diameter segment gradually becomes smaller, the temple of the glasses or other ornaments worn by the user can be effectively avoided, thereby improving the user experience.

In a specific embodiment, the first variable diameter segment of the ear hook is not cylindrical, but is irregularly shaped. Specifically, the thickness of the first variable diameter segment gradually decreases from the starting position to the end position, and the width of the first variable diameter segment also gradually decreases. In this embodiment, the thickness direction refers to a direction in which the ear is close to or away from the human ear, the length direction refers to an extension direction of the first variable diameter segment, and the width direction refers to a direction perpendicular to the length direction and the thickness direction. In this embodiment, since the first variable diameter segment gradually decreases in the thickness direction, the first variable diameter segment is thinnest at a region corresponding to the upper part of the human ear, so that better avoidance of temples of eyeglasses or accessories such as hairpins worn by the user can be provided, thereby improving the user experience.

As illustrated in a perspective view of the earphone in FIG. 16, in the embodiment provided by the present disclosure, the battery portion 204 has a cylindrical shape. One end of the battery portion 204 is connected to the ear hook 203, the other end of the battery portion 204 extends in a direction away from the ear hook 203, and an extending tail end of the battery portion 204 exceeds the sound-emitting portion 201. In this embodiment, the connection of the ear hook 203 and the battery portion 204 is located at a free end side of the sound-emitting portion 201. When the ear hook is in a non-wearing state, a distance between the free end of the sound-emitting portion and the connection of the ear hook and the battery portion 204 is h. In this embodiment, h ranges from 3 mm to 5 mm. In a specific embodiment, h is 3.6 mm.

In the embodiment of the present disclosure, in a wearing state, a region of the ear hook located around the suspension point of the upper part of the human ear is a top end of the ear hook. The sound-emitting portion 201 defines a front sound outlet hole 2011 on a surface of the sound-emitting portion 201 facing towards the ear canal. The sound-emitting portion 201 defines a rear sound outlet hole 2012 on a peripheral wall of the sound-emitting portion 201. The front sound outlet hole 2011 and the rear sound outlet hole 2012 are both curved, and both defined on surfaces of the sound-emitting portion 201 away from the top end of the ear hook 203.

In the above-mentioned embodiment, the sound-emitting portion 201 of the earphone 200 defines two sound outlet holes on the surfaces of the sound-emitting portion 201 away from the top end of the ear hook 203, namely, the front sound outlet hole 2011 and the rear sound outlet hole 2012, respectively. The front sound outlet hole 2011 and the rear sound outlet hole 2012 both are smooth and curved. Specifically, the front sound outlet hole 2011 is defined on the lower surface of the sound-emitting portion 201. The rear sound outlet hole 2012 is provided on the peripheral wall of the sound-emitting portion 201 covered by the first part. More specifically, the rear sound outlet hole 2012 extends along the peripheral wall of the sound-emitting portion 201 at the side of the sound-emitting portion 201 away from the ear hook 203. The front sound outlet hole 2011 extends on the lower surface of the sound-emitting portion 201 close to the rear sound outlet hole 2012, and a bending direction of the front sound outlet hole 2011 is opposite to a bending direction of the ear hook 203.

In the embodiment of the present disclosure, when the earphone 200 is in a wearing state, the bending direction of the curved front sound outlet hole 2011 is oriented towards the rear of the human ear. Compared with an earphone 200 in which the front sound outlet hole 2011 is oriented towards the upper side of the human ear, the earphone 200 in this embodiment is less prone to accumulation of impurities or the like in the region where the sound outlet hole is located, thereby maintaining greater cleanliness and tidiness.

In the embodiment of the present disclosure, a first microphone 2024 is provided at the end portion of the ear hook connected to the connecting member, and the first microphone 2024 is arranged away from the top end of the ear hook. A second microphone 2025 is provided at the sidewall of the housing facing towards the top end of the ear hook.

In a specific embodiment, two microphones, namely, the first microphone 2024 and the second microphone 2025, are further provided on the earphone 200. Specifically, the first microphone 2024 is disposed on the second part of the connecting member 202, and the second microphone 2025 is disposed on the ear hook 203. More specifically, the first microphone 2024 is disposed at the end portion of the ear hook 203 connected to the left sidewall of the second part, and the first microphone 2024 is disposed away from the top end of the ear hook. The second microphone 2025 is disposed at the sidewall of the second part of the housing facing towards the top end of the ear hook 203, and the sidewall of the housing facing towards the top end of the ear hook and the human ear form a wind-shielded region, that is, the second microphone 2025 is located in the wind-shielded region.

In the embodiment of the present disclosure, the second microphone 2025 is disposed towards the top end of the ear hook, and when the earphone 200 is in a wearing state, the second microphone 2025 is located in the wind-shielded region of the earphone, so that it is possible to avoid interference with the second microphone 2025 when the wind directly blows to the second microphone 2025, thereby improving the call quality.

In the embodiment of the present disclosure, when the earphone is placed in the earphone case, the thickness of the connecting member of the earphone exceeding the mounting recess accounts for at least one half of the total thickness of the connecting member.

In the above-mentioned embodiment, the thickness of the body portion of the earphone is 12 mm. The thickness of the sound-emitting portion exceeding the connecting member ranges from 2 mm to 4 mm, and the exceeding part of the sound-emitting portion is completely located in the sound-emitting-portion recess. The thickness of the third part of the connecting member ranges from 7 mm to 11 mm. The thickness of the connecting member exceeding the connecting-member recess ranges from 6 mm to 8 mm, when the earphone is placed in the earphone case.

In a specific embodiment, the thickness of the body portion of the earphone is 12 mm. The thickness of the sound-emitting portion exceeding the connecting member is 3 mm, and the exceeding part of the sound-emitting portion is completely located in the sound-emitting-portion recess. The thickness of the third part of the connecting member is 9 mm. The thickness of the connecting member exceeding the connecting-member recess is 7 mm, when the earphone is placed in the earphone case.

In addition, in this embodiment, the thickness of the battery portion is almost the same as the thickness of the body portion, and a ratio of the thickness of the battery portion exceeding the battery-portion recess to the total thickness of the battery portion is the same as a ratio of the thickness of the body portion exceeding the body-portion recess to the total thickness of the body portion.

In this embodiment, after the earphone is placed in the mounting recess, the thickness of the earphone exceeding the mounting recess is relatively large, thereby providing sufficient take-up space for the user and facilitating the user to perform the taking-and-placing operation on the earphone.

In the earphone 200 provided by the present disclosure, the step portion formed between the sound-emitting portion 201 and the connecting member 202 can avoid a part of the tragus, so that the sound-emitting portion 201 can be better located in the cavity of auricular concha. During the wearing of the earphone 200, the sound-emitting portion 201 does not easily come off from the cavity of auricular concha due to the shaking of the head, thereby avoiding affecting the user to receive the sound emitted by the earphone 200. This embodiment can improve the use experience of the user.

Even though the present disclosure has already shown and described multiple embodiments of the present disclosure, it is obvious for those of ordinary skill in the art that such embodiments are only provided through the method of examples. Those of ordinary skill in the art may conceive many changes and substitute methods without deviating ideas and spirits of the present disclosure. It should be understood that in the process of implementing the present disclosure, every kind of substitute schemes of the embodiments of the present disclosure described may be adopted. Accompanying claims aim at limiting protection scope of the present disclosure, and may cover equivalent or substitute embodiments in the scope of these claims.

What is claimed is:

1. A storage case, comprising an upper housing and a lower housing, wherein the upper housing and the lower housing cooperatively define an accommodating cavity for an object, and the lower housing defines a mounting recess; and the storage case further comprises:
a first positioning portion, wherein the first positioning portion is disposed on an inner surface of the upper housing facing towards the lower housing, and the first positioning portion protrudes towards the lower housing; and the first positioning portion is disposed adjacent to a first part of the mounting recess, and the first positioning portion and the first part of the mounting recess constitute a first positioning region; and
a second positioning portion, wherein the second positioning portion is disposed on the inner surface of the upper housing facing towards the accommodating cavity, and the second positioning portion has a flat surface or a curved surface; and the second positioning portion faces towards a second part of the mounting recess, and the second positioning portion and the second part of the mounting recess constitute a second positioning region;
wherein the first positioning region and the second positioning region cooperatively define a positioning cavity for the object.

2. An earphone case, comprising the storage case of claim 1, wherein the earphone case is configured to store an earphone.

3. The earphone case of claim 2, wherein an outer surface of a protruding part of the first positioning portion of the earphone case is a curved surface and is symmetrical about a first axis; and
the mounting recess comprises a first mounting recess and a second mounting recess that are symmetrical about the first axis, and the first positioning portion and both the first mounting recess and the second mounting recess form a plurality of first positioning regions.

4. The earphone case of claim 2, wherein the earphone comprises a body portion and a battery portion, the first positioning region is configured for positioning the battery portion, and the second positioning region is configured for positioning the body portion; and
the battery portion comprises a cylindrical housing, the first part of the mounting recess is configured to abut against a part of an outer surface of the cylindrical housing; and a curved surface of the first positioning portion is configured to be tangent to the outer surface of the cylindrical housing, or a shortest distance between the curved surface of the first positioning portion and the outer surface of the cylindrical housing is configured to range from 0.2 mm to 0.5 mm.

5. The earphone case of claim 2, wherein when the upper housing and the lower housing are in a closed state, an inner surface of the first positioning portion and an inner surface of the lower housing that face towards each other abut against each other, or a distance between the inner surface of the first positioning portion and the inner surface of the lower housing that face towards each other ranges from 4 mm to 6 mm.

6. The earphone case of claim 4, wherein a top surface of the body portion of the earphone is a flat surface or a curved surface; and
the second positioning portion has the flat surface, and when the earphone case is in a closed state, the second positioning portion is configured to abut against the top surface of the body portion, or the second positioning portion is configured to be parallel to the top surface of the body portion with a distance ranging from 0.2 mm to 0.5 mm therebetween;
or the second positioning portion has the curved surface, and when the earphone case is in a closed state, the curved surface of the second positioning portion is configured to abut against the top surface of the body portion, or a distance between the curved surface of the second positioning portion and the top surface of the body portion is configured to range from 0.2 mm to 0.5 mm.

7. The earphone case of claim 2, wherein the upper housing is a transparent housing or a translucent housing.

8. The earphone case of claim 2, wherein the upper housing defines a recess on an outer surface of the upper housing opposite to the first positioning portion, and the recess extends towards the accommodating cavity;
the first positioning portion has a first curved surface, the recess has a second curved surface, and the first curved surface is coaxial with the second curved surface; and
a curvature of the first curved surface is less than a curvature of the second curved surface, thereby forming a lens.

9. The earphone case of claim 2, wherein a shape of the mounting recess is configured to be adapted to a shape of a part of the earphone extending into the mounting recess, and the mounting recess at least comprises a body-portion recess, an ear-hook recess, and a battery-portion recess that are sequentially communicated.

10. The earphone case of claim 9, wherein the body-portion recess comprises a sound-emitting-portion recess and a connecting-member recess, and a depth of the sound-emitting-portion recess is larger than a depth of the connecting-member recess; and
the depth of the sound-emitting-portion recess is larger than a depth of the battery-portion recess, a depth of the ear-hook recess at a middle region of the ear-hook recess is larger than the depth of the sound-emitting-portion recess, a depth of the ear-hook recess at a region of the ear-hook recess close to the connecting-member recess is larger than the depth of the connecting-member recess, and a depth of the ear-hook recess at a region of the ear-hook recess close to the battery-portion recess is smaller than the depth of the battery-portion recess.

11. The earphone case of claim 9, wherein a flexible pad is provided at a bottom of each of the body-portion recess and the battery-portion recess.

12. The earphone case of claim 9, wherein a first magnetic member is provided in the sound-emitting-portion recess and/or the connecting-member recess, and is configured to magnetically attract a body portion of the earphone.

13. The earphone case of claim 9, wherein the lower housing is provided with a stopper, the stopper is disposed at a sidewall of the battery-portion recess away from the first positioning portion, the stopper, the battery-portion recess, and the first positioning portion cooperatively constitute a third positioning region for positioning a cylindrical surface of a battery portion of the earphone.

14. The earphone case of claim 13, wherein the stopper is provided with a functional member, and the functional member comprises a sensor or a charging contact.

15. The earphone case of claim 13, wherein a second magnetic member is provided at an inner side of the stopper and/or in the battery-portion recess, and the second magnetic member is configured to magnetically attract the battery portion of the earphone.

16. The earphone case of claim 2, wherein the upper housing is provided with a plurality of first positioning portions on the inner surface of the upper housing, the plurality of first positioning portions form a plurality of positioning points or positioning lines, and the plurality of first positioning portions are configured to limit the earphone by means of point or line contracts between the plurality of positioning points or positioning lines and an opposite region of an earphone housing.

17. The earphone case of claim 9, wherein the earphone case defines two independent cavities symmetrical about a first axis of symmetry; and
the battery-portion recess in each of the two cavities is defined close to a first axis, and the body-portion recess in each of the two cavities is defined away from the first axis relative to the battery-portion recess.

18. An earphone, placed in the earphone case of claim 2.

19. The earphone of claim 18, wherein the earphone comprises a body portion and a battery portion;
a top surface of the body portion is a flat surface or a curved surface, and when the earphone is placed in the mounting recess of the earphone case and the upper housing and the lower housing of the earphone case are in a closed state, the top surface of the body portion is configured to abut against or be spaced apart from the inner surface of the upper housing within a certain range; and
an outer surface of the battery portion is configured to be tangent to an outer surface of the first positioning portion on the upper housing, or a shortest distance between the outer surface of the first positioning portion and the outer surface of the battery portion is configured to range from 0.2 mm to 0.5 mm.

20. The earphone of claim 19, wherein the earphone comprises a stepped portion between a sound-emitting portion of the body portion and a connecting portion of the body portion.
